(19) United States
(12) Patent Application Publication
(10) Pub. No.: US 2012/0263500 A1
(43) Pub. Date: Oct. 18, 2012

(54) TRANSFER DEVICE AND IMAGE FORMATION APPARATUS

(75) Inventors: Yoshihisa SAKA, Shiojiri (JP); Tomoyuki SHIIYA, Matsumoto (JP)

(73) Assignee: SEIKO EPSON CORPORATION, Tokyo (JP)

(21) Appl. No.: 13/443,470

(22) Filed: Apr. 10, 2012

(30) Foreign Application Priority Data
Apr. 12, 2011 (JP) 2011-087991
Apr. 21, 2011 (JP) 2011-094784

(51) Int. Cl. G03G 15/16; G03G 15/04

(52) U.S. Cl. 399/177; 399/308

(57) ABSTRACT

In order to provide a device that can suppress speed fluctuations of an image carrier and prevent image disturbance caused thereby, tension rollers elastically supported by springs are disposed either side of a secondary transfer position where an intermediate transfer belt and a secondary transfer roller oppose one another, the secondary transfer roller having a recess part for accommodating a gripping part for gripping a recording material. The intermediate transfer belt is rotatably driven by a belt drive motor around which the intermediate transfer belt is wound in a position that is different from the secondary transfer backup roller. The speed fluctuations of the intermediate transfer belt that are generated in the secondary transfer position due to the rotation of the secondary transfer roller are absorbed by the two tension rollers and have no effect on image formation.

### CROSS-REFERENCE TO RELATED APPLICATIONS

This application is based on Japanese Patent Application No. 2011-87991 filed on Apr. 12, 2011 and Japanese Patent Application No. 2011-94784 filed on Apr. 21, 2011, the entire specification, drawings, and abstract of which are hereby incorporated by reference.

### BACKGROUND

1. Technical Field

The present invention relates to an image formation apparatus and a transfer device provided with a belt-shaped image carrier for carrying an image, and a transfer roller that is in contact with the image carrier to form a transfer nip and that has a shape in which a portion of a cylindrical peripheral surface is notched.

This invention also relates to an image formation apparatus in which recording paper or other transfer material is pressed by a transfer roller into contact with an image-carrying belt that carries an image formed by a developer containing toner and carrier fluid to transfer an image to the transfer material.

2. Background Technology

In the field of image formation technology for forming an image on paper or another recording material, there are configurations in which an image temporarily formed on a belt-shaped image carrier is transferred to a recording material. For example, in the image formation apparatus described in Patent Document 1, an image forming station forms an image on a transfer belt that serves as an image carrier suspended across a plurality of rollers, and the recording material is made to pass through a transfer nip in which the transfer belt and a secondary transfer roller are in contact with each other, whereby the image is transferred from the transfer belt to the recording material.

It is preferred that considerable pressing force be applied to the recording material that passes through the transfer nip in order for the image transfer to be carried out with high transfer efficiency from the image carrier to the recording material. On the other hand, the application of considerable pressing force is liable to cause the recording material to adhere to the image carrier. For example, the image formation apparatus described in Patent Document 1 (e.g., FIG. 1 in Japanese Laid-open Patent Application No. 2008-122815) is a so-called liquid development scheme in which an electrostatic latent image is developed by a developer dispersed in a liquid carrier, and adhesion of the recording material readily occurs due to left over liquid carrier.

In order to solve such a problem, it is possible to consider the use of the technique described in, e.g., Patent Document 2 (e.g., FIG. 2A of Japanese Domestic Re-publication No. 2000-508280). The imaging device described in Patent Document 2 has an openable gripper provided as a gripping member to a portion of the peripheral surface of a cylindrical pressing roller (corresponding to the transfer roller), and the adhering action of the recording material to an intermediate transfer member that makes contact with the pressing roller is prevented by the end part of the recording material being gripped by the gripper. The intermediate transfer member, which is an image carrier in Patent Document 2, is a roller-shape rolling body.

There have been a well-known image formation apparatus that performs a primary transfer in which a toner image formed on an image carrier by an image forming unit is transferred onto a rotatable image-carrying belt by a primary transfer section, and the toner image carried on the image-carrying belt is transferred to a transfer material by a secondary transfer nip, wherein tension rollers are provided for adjusting the tension of the image-carrying belt to the near side in the rotational direction of the image-carrying belt from the secondary transfer nip, and the rotational direction of the image-carrying belt from the secondary transfer nip (Patent Document 3: Japanese Laid-open Patent Application No. 10-268595).

Vibration in the secondary transfer section is absorbed and mitigated by the tension rollers, the transmission of vibrations to the primary transfer section is reduced, and impacts that occur when the transfer material is fed into the secondary transfer nip is absorbed and mitigated.

There is known an image formation apparatus in which improved primary transfer efficiency is obtained by winding the transfer belt, which is a image-carrying belt, onto a photosensitive drum, which is an image carrier (see Patent Document 4: Japanese Laid-open Patent Application No. 2010-48847).

There is also known a tandem-scheme image formation apparatus having a plurality of different-colored image formation units and that sequentially carries out primary transfers onto an image-carrying belt that rotates a toner image formed on the image carriers to superimpose the colors and form a color image. In the image formation apparatus, a plurality of image carriers make contact with the image-carrying belt to transfer an image in a mode for forming a color image, and keeps other colors set at a distance from the image-carrying belt in a mode for forming a monochrome image and only the image carrier having a single color makes contact with the image-carrying belt to transfer the image (see Patent Document 5: Japanese Laid-open Patent Application No. 2007-178867).

### SUMMARY

The following problems arise in the case that Patent Documents 1 and 2 described above are combined together. In other words, the gripping member is attached to the pressing roller in Patent Document 2, so the peripheral surface is not a cylindrical surface, and this causes the pressing force of the transfer nip to fluctuate in synchrony with the rotational cycle of the pressing roller. Such fluctuation creates a speed fluctuation in the belt-shaped image carrier in the case that the image carrier in contact with the pressing roller is a belt-shaped image carrier, and as a result, the image formed on the image carrier by the image-forming station becomes disarranged.

Such a problem is the same as a case in which a transfer roller that does not have a cylindrical peripheral surface is used, and can also occur in the case of a transfer roller having a shape in which a portion of the cylindrical peripheral surface is notched. In other words, when the image carrier faces the cylindrical peripheral surface part of the transfer roller and makes contact with the surface thereof, and when the image carrier faces the notched portion of the transfer roller and is set at a distance from the surface of the transfer roller, the pressing force applied to the image carrier surface is considerably different, wherefore considerable speed fluctuation occurs during a switch between these two situations. This is particularly dramatic in the case that a transfer roller is used that has a notched portion that is larger in dimension than the width of the transfer nip.

Several modes according to the invention provide art that is capable of solving the above-described problems in a transfer device and image formation apparatus having a belt-shaped image carrier (or transfer belt, and the same applies hereinbelow) and a transfer roller in which a portion of the peripheral surface has a notched shape, and that can prevent disarrangement of an image caused by the problems.

In order to solve the above-described problems, the transfer device according to the invention has a belt-shaped image carrier for carrying an image; a drive roller for winding and moving the image carrier, which is carrying an image; a first tension roller for imparting a tensile force to the image carrier and winding the image carrier moved by the drive roller; a first elastic support part that has a first elastic member for generating the tensile force and that supports one rotating shaft of the first tension roller; a second elastic support part that has a second elastic member for generating the tensile force and that supports another rotating shaft of the first tension roller; a backup roller for winding the image carrier, which has been wound onto the tension roller; a transfer roller that has a recess part in the peripheral surface and that makes contact with the image carrier wound on the backup roller to form a transfer nip; and a second tension roller for imparting a tensile force to the image carrier and winding the image carrier wound on the backup roller.

The image formation apparatus according to the invention has a belt-shaped image carrier for carrying an image; an imaging section for forming an image and transferring the image to the image carrier; a first drive source for generating driving force; a drive roller for transmitting the driving force generated by the first drive source to the image carrier, and winding and driving the image carrier onto which the image has been transferred by the imaging section, the drive roller being connected to the first drive source; a first tension roller for imparting a tensile force to the image carrier and winding the image carrier moved by the drive roller; a first elastic support part that has a first elastic member for generating the tensile force and that supports one rotating shaft of the first tension roller; a second elastic support part that has a second elastic member for generating the tensile force and that supports another rotating shaft of the first tension roller; a backup roller for winding the image carrier, which has been wound onto the tension roller; a second drive source for generating driving force; a transfer roller that has a recess part in the peripheral surface, that makes contact with the image carrier wound on the backup roller to form a transfer nip, and that is rotatably driven by the second drive source; and a second tension roller for imparting a tensile force to the image carrier and winding the image carrier wound on the backup roller.

The image formation apparatus according to the invention has a configuration in which the reverse-side surface is opposite from the surface on which the image of the image carrier has been transferred is wound on the first tension roller and the second tension roller.

The image formation apparatus according to the invention has a cleaning section for making contact with the image carrier wound on the second tension roller to clean the image carrier; and a second imaging section for forming an second image and transferring the second image to the image carrier cleaned by the cleaning unit, wherein the imaging section transfers the image to the image carrier to which the second image has been transferred; and the peripheral length of the image carrier from the transfer nip to the position in which the second imaging section transfers the image to the image carrier, along the direction of movement of the image carrier, is greater than the peripheral length of the image carrier from the position in which the imaging section transfers the image to the image carrier to the transfer nip.

The image formation apparatus according to the invention has a steering roller on which the image carrier wound on the second tension roller is wound, and which adjusts the position of the drive roller of the image carrier in the axial direction.

The image formation apparatus according to the invention has a first side plate for supporting one of the rotating shafts of the drive roller, the rotating shafts of the first tension roller, the rotating shafts of the second tension roller, and rotating shafts of the steering roller; a second side plate for supporting the other of the rotating shafts of the drive roller, the rotating shafts of the first tension roller, and the rotating shafts of the second tension roller; a third side plate for supporting the other rotating shaft of the steering roller; and a moving member for moving the third side plate.

The image formation apparatus according to the invention has a first roller support member for supporting one of the rotating shafts of the second tension roller, the first roller support member having a third elastic member; a second roller support member for supporting the other of the rotating shafts of the second tension roller, the second roller support member having a fourth elastic member; and a coupling member connected to the first roller support member and the second roller support member.

The image formation apparatus according to the invention has a gripping mechanism for gripping a recording material to which the image has been transferred, the gripping mechanism being arranged in the recess part of the transfer roller.

As described above, the transfer device and the image formation apparatus of the invention operate so as to nullify fluctuations in the tensile force in the movement direction of the belt-shaped image carrier, and operate so as to nullify fluctuations in the tensile force independently at one end and the other end in the direction orthogonal to the movement direction of the belt-shaped image carrier. As a result, an effect in which the toner image transferred from the image formation stations is disturbed and the image quality is reduced can be prevented in advance.

When the contact or separation action between the photoreception drum and the image-carrying belt is carried out in accompaniment with switching between the full-color image formation mode and the monochrome image formation mode described in Patent Document 5, the stretched-out shape of the image-carrying belt wound around the image carrier changes, in contrast to the image formation apparatus described in Patent Document 4 in which the image-carrying belt is wound around the image carrier. When the image-carrying belt is stretched out by a tension roller as described in Patent Document 3, the change in the image-carrying belt is absorbed by the change in position of the two tension rollers disposed before and after the secondary transfer nip in the movement direction of the image-carrying belt, and the tension force of the image-carrying belt is kept substantially constant. However, since the movement time of the image-carrying belt from the primary transfer section to the secondary transfer section changes due to the change in the position of the tension roller on the side in front of the secondary transfer nip, there is a difference in the timing at which the image carried on the image-carrying belt enters the secondary transfer nip and the timing at which the transfer material is fed to the secondary transfer nip, and the position of the image in relation to the transfer material is liable to change.

The invention was devised in view of such circumstances, and an advantage thereof is to provide an image formation apparatus that can transfer an image in a good position on the transfer material, even when the trajectory in which the image-carrying belt moves has changed due to a contact or separation action of the image carrier in contact with the image-carrying belt.

The image formation apparatus according to the invention has a first latent image carrier drum for carrying a latent image; a first exposure section for exposing the first latent image carrier drum and forming the latent image; a first development section for developing, using a first developer that includes a black-colored pigment, the latent image formed on the first latent image carrier; a first transfer section for transferring a first image developed in the first development section; a second latent image carrier drum for carrying a latent image; a second exposure section for exposing the second latent image carrier drum and forming the latent image; a second development section for developing, using a second developer, the latent image formed on the second latent image carrier; a second transfer section for transferring a second image developed in the second development section; an image-carrying belt onto which the first image is transferred, the image-carrying belt having been wound around the first latent image carrier drum in the first transfer section, and onto which the second image is transferred, the image-carrying belt having been wound around the second latent image carrier drum in the second transfer section; a first tension roller around which is wound the image carrier onto which the first image and the second image have been transferred, the first tension roller adapted to impart tensile force to the image-carrying belt; a stretch-out roller around which is wound the image-carrying belt that has been wound around the first tension roller; a transfer roller for transferring to a transfer material the first image and the second image transferred on the image-carrying belt, upon contact having been made with the stretch-out roller interposed by the image-carrying belt; a second tension roller around which is wound the image-carrying belt wound around the stretch-out roller, the second tension roller adapted to impart tensile force to the image-carrying belt; a contact/separation mechanism for causing the second latent image carrier drum to make contact with or move away from the image-carrying belt; and a controller for causing the second latent image carrier and the image-carrying belt to make contact with or move away from each other using the contact/separation mechanism, causing the first exposure section to expose at a first exposure timing when the second latent image carrier and the image-carrying belt have been brought into contact with each other, and causing the first exposure section to expose at second exposure timing that is different from the first exposure timing when the second latent image carrier and the image-carrying belt have been moved away from each other.

The image formation apparatus also has a detector for detecting the position of the image-carrying belt set in advance.

The controller controls the exposure of the first exposure section by using as a first exposure timing the elapsing of a first time after the position of the image-carrying belt set in advance is detected by the detector, and by using as a second exposure timing the elapsing of a second time that is different from the first time after the position of the image-carrying belt set in advance is detected by the detector.

The image formation apparatus also has a storage section for storing information related to the first time and the second time.

The first time is later than the second time.

The detector is arranged in a position upstream of where the first image and the second image are transferred and the image carrier is wound around the first tension roller; the image formation apparatus further includes: a second stretch-out roller around which is wound the image-carrying belt wound around the second tension roller, and a second detector for detecting the position of the image-carrying belt set in advance, the second detector being arranged in a position upstream of where the image-carrying belt is wound over the stretch-out roller and wound over the second stretch-out roller. The controller controls the first exposure timing and the second exposure timing on the basis of the time beginning from when the detector detects the position of the image-carrying belt set in advance and the time ending when second detector detects the position of the image-carrying belt set in advance.

The transfer roller has a recess part in a peripheral surface, and has a gripping member for gripping the transfer material, the gripping member being arranged in the recess part.

In accordance with the invention, the image can be transferred in a good position on the transfer material even when the trajectory in which image-carrying belt moves has changed due to the contact/separation action of the image carrier in contact with the image-carrying belt.

### BRIEF DESCRIPTION OF THE DRAWINGS

Referring now to the attached drawings which form a part of this original disclosure:

FIG. 1 is a view showing a first embodiment of the image formation apparatus of the invention;

FIG. 2 is a block diagram showing the electrical configuration of the device of FIG. 1;

FIG. 3 is a perspective view showing the overall configuration of the secondary transfer roller;

FIG. 4 is a view for more specifically illustrating the configuration of the tension rollers in the width direction in the first embodiment;

FIG. 5 is a timing chart showing an operation example of the image formation apparatus of FIG. 1;

FIG. 6 is a first view that schematically shows the operation of the image formation apparatus of FIG. 1;

FIG. 7 is a second view that schematically shows the operation of the image formation apparatus of FIG. 1;

FIG. 8 is a view showing a second embodiment of the image formation apparatus according to the invention;

FIG. 9 is a view for illustrating in detail the configuration of the transfer device in the second embodiment;

FIG. 10 is a view showing the main constituent elements constituting the image formation apparatus according to a third embodiment of the invention;

FIG. 11 is a view showing the state in which the belt position sensor detects the detection mark of the intermediate transfer belt;

FIG. 12 is a view of the cross section A-A of FIG. 11 as seen from the arrow direction;

FIG. 13 is a view showing the state of intermediate transfer belt and the photoreceptor in the full-color image formation mode and the black monochrome image formation mode;

FIG. 14 is a block view of the control system of the exposure section and the gate roller;

FIG. 15 is a timing chart of the light-emission of the exposure section and the rotatable operation of the gate roller;

FIG. 16 is a view showing the main constituent elements constituting the image formation apparatus according to a fourth embodiment of the invention;

FIG. 17 is a view showing the state in which the second belt position sensor detects the detection mark of the intermediate transfer belt;

FIG. 18 is a block view of the control system of the exposure section and the gate roller;

FIG. 19 is a timing chart of the light-emission of the exposure section and the rotatable operation of the gate roller;

FIG. 20 is a view showing the main constituent elements constituting the image formation apparatus according to a fifth embodiment of the invention;

FIG. 21 is a block view of the control system of the exposure section and the gate roller; and

FIG. 22 is a timing chart of the light-emission of the exposure section, the rotatable operation of the gate roller, and the rotatable operation of the secondary transfer roller.

### DETAILED DESCRIPTION OF EXEMPLARY EMBODIMENTS

### First Embodiment

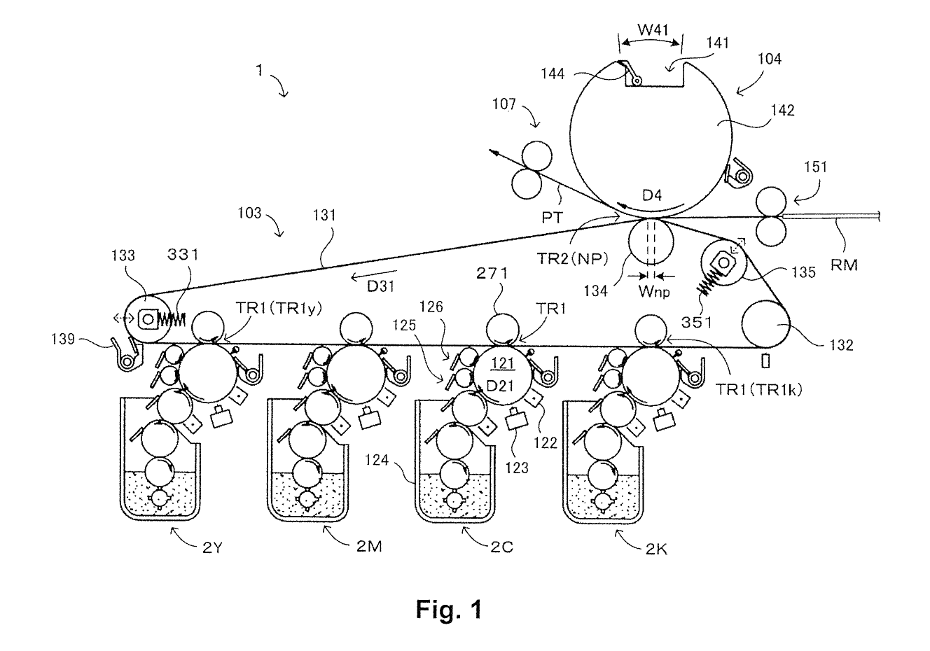

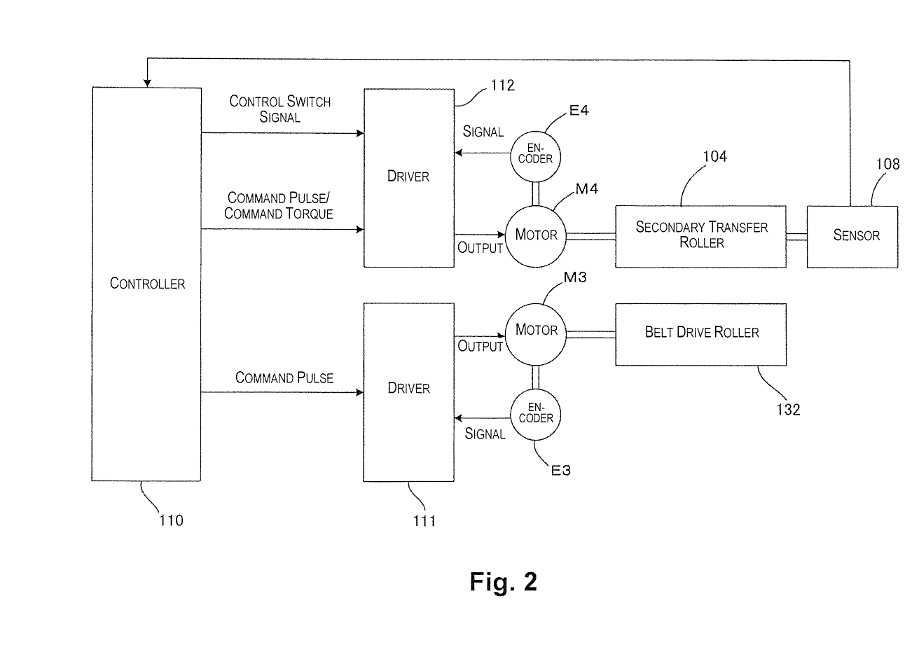

FIG. 1 is a view showing a first embodiment of the image formation apparatus of the invention. FIG. 2 is a block diagram showing the first embodiment of the electrical configuration of the device of FIG. 1. The image formation apparatus 1 is provided with four image formation stations 2Y (yellow), 2M (magenta), 2C (cyan), and 2K (black) that form images with mutually different colors. The image formation apparatus 1 is capable of selectively executing a color mode for superimposing four color toners yellow (Y), magenta (M), cyan (C), and black (K) to form a color image, and a monochrome mode for forming a monochrome image using only black (K) toner. In this image formation apparatus, the controller 110 controls each component of the device and executes a predetermined image formation operation when an image formation command is given to a controller 110 having a CPU, memory, and the like from a host computer or other external device, and an image that corresponds to the image formation command is formed on copy paper, transfer paper, form paper, a transparent sheet for an OHP, or another recording material RM in the form of a sheet.

The image formation stations 2Y, 2M, 2C, and 2K have the same structure and function except for the toner color. In view of this, reference numerals are assigned to the components constituting the image formation station 2C, and the reference numerals for the other image formation stations 2Y, 2M, and 2K have been omitted in FIG. 1 in order to make the drawings easier to view. In the description below, the structure and operation of the image formation station 2C will be described with reference to the reference numerals used in FIG. 1, and the structure and operation of the other image formation stations 2Y, 2M, and 2K are also the same except that the toner colors are different.

A photoreceptor drum 121 on which a cyan-colored toner image is formed on the surface thereof is disposed in the image formation station 2C. The photoreceptor drum 121 is arranged so that the rotational axis thereof is parallel or substantially parallel to the main scanning direction (the direction perpendicular to the page of FIG. 1), and is rotatably driven at a predetermined speed in the direction of the arrow D21 in FIG. 1.

Disposed at the periphery of the photoreceptor drum 121 along the rotation direction D21 (clockwise in FIG. 1) of the photoreceptor drum 121 are, in sequence, a charger 122, which is a corona charging unit for charging the surface of the photoreceptor drum 121 to a predetermined electric potential; an exposure unit 123 for forming an electrostatic latent image by exposing the surface of the photoreceptor drum 121 in accordance with an image signal; a developing unit 124 for developing the electrostatic latent image as a toner image; a first squeeze section 125; a second squeeze section 126; a primary transfer unit for performing a primary transfer of the toner image to an intermediate transfer belt 131 of a transfer unit 103; and a cleaner blade for cleaning the surface of the photoreceptor drum 121 after transfer.

The charger 122 does not make contact with the surface of the photoreceptor drum 121, and well-known corona charging can be used as the charger 122. In the case that a scorotron charger is used as the corona charger, a wire electric current is allowed to flow to the charge wire of the scorotron charger, and a direct current (DC) grid static bias is applied to the grid. The photoreceptor drum 121 is charged by corona discharge by the charger 122, whereby the electric potential of the surface of the photoreceptor drum 121 is set to a substantially uniform electric potential.

The exposure unit 123 exposes the surface of the photoreceptor drum 121 using a light beam in accordance with an image signal provided by an external device to form an electrostatic latent image that corresponds to the image signal. The exposure unit 123 can have a configuration in which a light beam from a semiconductor laser is made to scan in the main scanning direction by a polygon mirror, or can be configured as a line head or the like in which light-emitting elements are arrayed in the main scanning direction.

Toner is applied by the developing unit 124 to the electrostatic latent image formed in this manner and the electrostatic latent image is developed by the toner. In the developing unit 124 of the image formation apparatus 1, toner development is carried out using a developer in which toner has been dispersed in the carrier fluid in a weight ratio of about 20%. In this embodiment, a high-viscosity (about 30 to 10000 mPa·s) developer having a toner solid-contents concentration of 15 to 30 wt % is used in place of a commonly used volatile developer that uses Isopar (registered trade name of Exxon) as the carrier fluid and that has volatility at low concentration (1 to 2 wt %) and low viscosity at normal temperature. The developer of this embodiment is composed of solid particles (toner) having an average grain diameter of 1 μm in which a pigment or another colorant is dispersed in resin, and the solid particles are added together with a dispersant to a nonvolatile organic solvent, silicone oil, mineral oil, edible oil, or other liquid solvent at normal temperature.

A squeeze roller is provided to the first squeeze section 125 and to the second squeeze section 126. The squeeze rollers makes contact with the surface of the photoreceptor drum 121 and removes excess toner fog and excess carrier fluid of the toner image. In the present embodiment, the excess carrier fluid and toner fog are removed by the two squeeze sections 125, 126, but it is possible to arrange, e.g., a single squeeze section, and no limit is imposed on the number, arrangement, and the like of the squeeze section.

The toner image having passed by the squeeze sections 125, 126 undergoes primary transfer to the intermediate transfer belt 131 by the primary transfer unit. The intermediate transfer belt 131 is an endless belt that serves as the image carrier capable of temporarily carrying the toner image on its surface, more specifically, on its external peripheral surface, and is suspended across a plurality of rollers 132, 133, 134, and 135. Among these rollers, the roller 132 is mechanically connected to a belt drive motor M3 and functions as a belt drive roller for driving the intermediate transfer belt 131 in a revolving fashion in the arrow direction D31 of FIG. 1. A driver 111 for driving the belt drive motor M3 is provided in the present embodiment, and the driver 111 outputs to the belt drive motor M3 a drive signal that corresponds to a command pulse received from the controller 110, as shown in FIG. 2. The belt drive roller 132 thereby rotates at a peripheral speed that corresponds to the command pulse and the surface of the intermediate transfer belt 131 moves in a revolving fashion at a constant speed in the direction D31. The reference numeral E3 in the drawing is an encoder attached to the belt drive motor M3. The encoder gives to the driver 111 a signal that corresponds to the rotation of the belt drive motor M3, and the driver 111 having thus received the signal provides feedback control of the belt drive motor M3 on the basis of the signal.

Described more specifically, among the rollers 132 to 135 across which the intermediate transfer belt 131 is suspended, only the belt drive roller 132 described above is driven by the motor, and the other rollers 133, 134, and 135 are driven rollers that do not have a drive source.

The primary transfer unit has a primary transfer backup roller 271, and the primary transfer backup roller 271 is disposed facing the photoreceptor drum 121 with the intermediate transfer belt 131 disposed therebetween. In the primary transfer position TR1 in which the photoreceptor drum 121 and the intermediate transfer belt 131 are in contact with each other, the toner image on the photoreceptor drum 121 is transferred to the external peripheral surface (the lower surface in the primary transfer position TR1) of the intermediate transfer belt 131. A cyan-colored toner image formed by the image formation station 2C is transferred in this manner to the intermediate transfer belt 131. Similarly, a toner image is transferred in the other image formation stations 2Y, 2M, and 2K, whereby a toner image of each color is sequentially superimposed on the intermediate transfer belt 131 and a full-color toner image is formed. On the other hand, a toner image is transferred to the intermediate transfer belt 131 in only the image formation station 2K, which corresponds to black, when a monochrome toner image is formed.

The toner image transferred to the intermediate transfer belt 131 in this manner is conveyed to a secondary transfer position TR2. In the secondary transfer position TR2, a secondary transfer roller 104 is disposed facing the roller 134 on which the intermediate transfer belt 131 is wound, with the intermediate transfer belt 131 disposed therebetween. The surface of the intermediate transfer belt 131 and the surface of the secondary transfer roller 104 are in contact with each other to form a transfer nip. In other words, the roller 134 functions as a secondary backup roller.

In the secondary transfer position TR2, a toner image having a single color or a plurality of colors formed on the intermediate transfer belt 131 is transferred to the recording material RM conveyed from a pair of gate rollers 151 along a conveyance path PT. In this embodiment, a toner image is formed using a liquid development scheme for forming a toner image using a developer. Therefore, the recording material RM is preferably pressed with high pressing force to the intermediate transfer belt 131 in the transfer nip in order to obtain good transfer characteristics. There is also a high possibility that the recording material RM will become adhere to the intermediate transfer belt 131 and become jammed because the developer is present therebetween. In view of the above, in this embodiment, a secondary transfer roller 104 having a gripping part is used as later described.

The recording material RM onto which the toner image has been secondarily transferred is sent from the secondary transfer roller 104 to a fuser (not shown) by a conveyance roller 107 disposed on the conveyance path PT. Heat, pressure, and the like are applied in the fuser to the toner image transferred to the recording material RM, and the toner image is fused to the recording material RM.

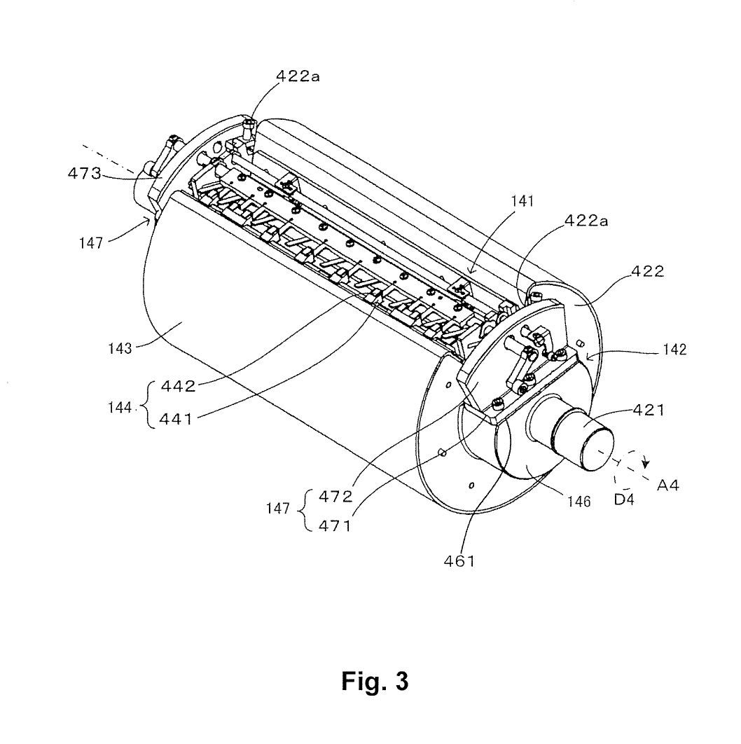

FIG. 3 is a perspective view showing the overall configuration of the secondary transfer roller. The secondary transfer roller 104 has a roller base 142 in which a recess part 141 formed by notching a portion of the external peripheral surface of the cylinder is provided, as shown in FIGS. 1 and 3. In the roller base 142, a rotating shaft 421 that freely rotates in the direction D4 about the center of the rotational axis A4 is arranged parallel to or substantially parallel to the rotational axis of the secondary transfer backup roller 134, and side plates 422, 422 are provided at the two ends of the rotating shaft 421. More specifically, the side plates 422, 422 both have a shape in which a notched part 422a is provided to the disk-shaped metal plate. The notched parts 422a, 422a are attached facing each other to the rotating shaft 421 and are set away from each other by a distance that is slightly greater than the width of the intermediate transfer belt 131, as shown in FIG. 3. In this manner, the roller base 142 is formed having a drum shape overall, but has a recess part 141 in a portion of the external peripheral surface thereof that extends parallel to or substantially parallel to the rotating shaft 421.

The external peripheral surface of the roller base 142, i.e., the metal plate surface has an elastic layer 143 composed of rubber, resin, or the like formed on the surface region excluding the region that corresponds to the interior of the recess part 141. The elastic layer 143 forms a transfer nip NP facing the intermediate transfer belt 131 wound around the drive roller 132.

A gripping part 144 for gripping the recording material RM is arranged inside the recess part 141. The gripping part 144 has a gripper support member 441 erectly provided to the external peripheral surface of the roller base 142 from the bottom part of the recess part 141, and a gripper support member 441 supported so as to allow free contact with and separation from the distal end part of the gripper support member 441. Also, a gripper member 442 is connected to a gripper drive member (not shown). A grip-release command is received from the controller 110 and the gripper drive section operates, whereby the distal end of the gripper member 442 separates from the distal end part of the gripper support member 441 to perform gripping preparation and gripping release of the recording material RM. On the other hand, a grip command is received from the controller 110 and the gripper drive section operates, whereby the distal end part of the gripper member 442 moves to the distal end part of the gripper support member 441 and grips the recording material RM. The configuration of the gripping part 144 is not limited to the present embodiment, and it is also possible to used a known gripping mechanism described in, e.g., Patent Document 2.

At the two end parts of the secondary transfer roller 104, a support member 146 is attached to the external side surface of the side plates 422, and is capable of integral rotation with the roller base 142. Also, a flat surface region 461 is formed in correspondence to the recess part 141. Transfer roller-side stop members 147 are attached to the flat surface region 461. In the stop members 147, a base area 471 us attached to the support member 146, a stop member 472 that is provided so as to extend in the normal direction of the flat surface region 461 from the base area 471, and the distal end part of the stop member 472 extends to the vicinity of the opening-side end part of the recess part 141. In other words, when the roller base 142 is viewed from the end part of the rotating shaft 421, the stop members 147 are arranged so as to block off the recess part 141. Therefore, the stop members 147 make contact with the end part surface of the secondary transfer backup roller 134 in the case that the recess part 141 has arrived at a position that faces the intermediate transfer belt 131 by the rotation of the secondary transfer roller 104. The distance between the secondary transfer roller 104 and the secondary transfer backup roller 134 can thereby be restricted.

In this embodiment, the opening part length (opening width) W41 of the recess part 141 of the roller base 142 along the rotational direction D4 is about 105 mm. When the elastic layer 143, which is formed in regions of the external peripheral surface of the secondary transfer roller 104 excluding the recess part 141, is in a position facing the intermediate transfer belt 131, the elastic layer 143 is pressed to the intermediate transfer belt 131 and the transfer nip NP is formed. The length (transfer nip width) Wnp of the transfer nip NP of the roller base 142 along the rotational direction D4 is about 11 mm, and is in a relationship in which the opening part length W41 of the recess part 141 is greater than the transfer nip width Wnp at the transfer nip NP. Therefore, in a state in which the recess part 141 of the secondary transfer roller 104 faces the intermediate transfer belt 131, the secondary transfer roller 104 and the intermediate transfer belt 131 are set apart from each other and the transfer nip is temporarily lost.

The length of the elastic layer 143 of the roller base 142 along the rotational direction D4 is set to about 495 mm, and this allows the largest-sized recording material RM that can be used in the device 1 to be wound. In other words, the length of the elastic layer 143 is set so that the length of the roller base 142 in the rotational direction D4 is greater than the length of the largest recording material among recording material that can be used.

A transfer roller drive motor M4 is mechanically connected to the rotating shaft 421 of the secondary transfer roller 104. In the present embodiment, a driver 112 is provided for driving the transfer roller drive motor M4. The driver 112 drives the motor M4 in accordance with a command given by the controller 110 and rotatably drives the secondary transfer roller 104 in the direction D4, which is clockwise within the plane of FIG. 1, i.e., the width direction in relation to the belt movement direction D31. The secondary transfer backup roller 134 is a driven roller that does not itself have a drive source. It is possible to prevent slippage between the intermediate transfer belt 131 and the secondary transfer roller 104 at the transfer nip NP, or between the intermediate transfer belt 131 and the secondary transfer backup roller 134 by making the secondary transfer backup roller 134 facing the motor-driven secondary transfer roller 104 to be a driven roller.

The present embodiment uses an AC servomotor as the motor M4, and is configured so that the AC servomotor can be positionally controlled by the driver 112 and so that torque can be controlled. In other words, the driver 112 has a position control circuit and a torque control circuit, and positional control and torque control can be selectively carried out. The controller 110 can input to the driver 112 a command pulse related to the positional information, and a control switching signal and a command torque related to the torque information.

The reference numeral E4 in FIG. 2 is an encoder attached to the transfer roller drive motor M4, the encoder gives to the driver 112 a signal that corresponds to the rotation of the transfer roller drive motor M4, and the driver 112 having thus received the signal provided feedback control of the motor M4 on the basis of the signal. Also, the reference numeral 108 is a phase detection sensor linked to one end part of the rotating shaft 421 of the secondary transfer roller 104, and the controller 110 can ascertain the rotational phase of the secondary transfer roller 104 from the output of the phase detection sensor 108.

In FIG. 1, among the rollers across which the intermediate transfer belt 131 is suspended, the rollers 133, 135 disposed in positions with the transfer nip NP therebetween are tension rollers in which the rotating shafts thereof are elastically supported to adjust the tensile force of the intermediate transfer belt 131.

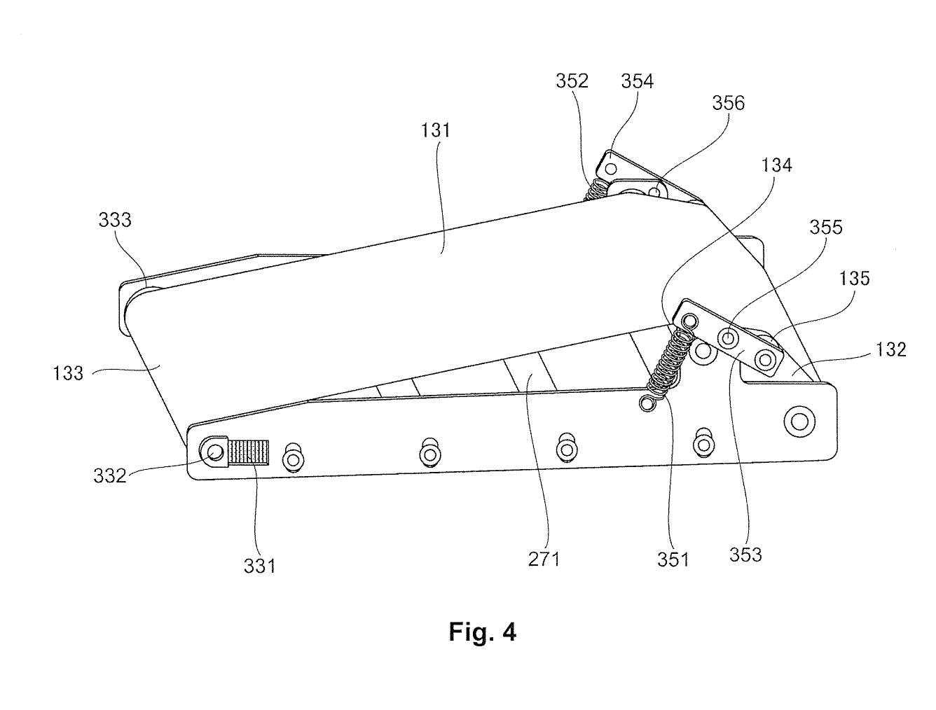

FIG. 4 is a view for more specifically describing the configuration of the tension rollers 133, 135 in the width direction in the first embodiment. The rotating shaft of tension roller 133 is elastically urged by springs 331 and 333 that are freely retractable in substantially the horizontal direction, whereby the tension roller 133 can freely move a predetermined distance in substantially the horizontal direction in a state with the intermediate transfer belt 131 wound thereon.

The rotating shafts at the two ends of the tension roller 135 are each independently held by a frame 353 at one end and a frame 354 at the other end, and each rotating shaft holds rotational support points 355, 356. The rotating shafts are elastically urged by two springs 351, 352 in the direction substantially orthogonal to the virtual plane in contact with the external peripheral surface of the belt drive roller 132 as well as the external peripheral surface of the secondary transfer backup roller 134. The rotating shafts at the two ends of the tension roller 135 can thereby be independently moved a predetermined distance in the urging direction in a state with the intermediate transfer belt 131 wound thereon.

In FIG. 1, in the secondary transfer position TR2, the load torque on the belt drive motor M3 for driving the belt drive roller 132 fluctuates considerably when the surface of the secondary transfer roller 104 facing the intermediate transfer belt 131 switches from the elastic layer 143 to the recess part 141 or conversely switches from the recess part 141 to the elastic layer 143, in accompaniment with the rotation with the secondary transfer roller 104. The fluctuation is particularly great in the case that a high pressing force is applied between the elastic layer 143 and the intermediate transfer belt 131. It is possible that this can cause the speed of the intermediate transfer belt 131 to fluctuate, vibrations to occur, and the tensile force of the belt 131 to temporarily vary.

However, in this embodiment, the pair of tension rollers 133, 135 is provided so that the secondary transfer position TR2 is disposed therebetween, and moving the rotating shafts thereof along the stretched-out direction of the intermediate transfer belt 131 acts to nullify the fluctuations in tensile force. Accordingly, the fluctuation in speed and the vibrations of the intermediate transfer belt 131 at the secondary transfer position TR2 can be prevented from affecting the primary transfer positions TR1 that correspond to the image formation stations 2Y, 2M, 2C, and 2K. The fluctuation in speed and the vibrations of the intermediate transfer belt 131 at the primary transfer positions TR1 disturb and reduce the image quality of the toner image transferred from the image formation stations, but in this embodiment, such an effect on image formation is prevented in advance. The transfer belt is driven by a drive roller in a region distant from the contact location with the tension rollers 133, 135, whereby the fluctuations in the speed of the transfer belt in this region can be more reliably suppressed.

When there is variability in the pressing force in the width direction of the intermediate transfer belt 131 in the secondary transfer position TR2, temporary variation in the tensile force of the intermediate transfer belt 131 due to the speed fluctuations and vibrations becomes nonuniform in the width direction. This causes the intermediate transfer belt 131 to be driven in an unstable manner, causes meandering or skewing to occur, and causes image quality to be reduced.

However, in the this embodiment, the rotating shafts at the two ends of the tension roller 135 can move independently in the urging direction, and thereby operate so as to nullify the nonuniformity even when the change in tensile force of the intermediate transfer belt 131 has become nonuniform in the width direction. Thus, the stability of the driving of the intermediate transfer belt 131 is maintained, and the reduction in image quality due to meandering and skewing is prevented in advance.

Both of the tension rollers 133, 135 are in contact with the intermediate transfer belt 131 from the reverse surface side that is on the opposite side of the surface, which is the inner side of the intermediate transfer belt 131, i.e., the image-carrying surface of the intermediate transfer belt 131. The reasons for this are as follows. First, the tension rollers 133, 135, by being in contact with the opposite side of the image-carrying surface, do not disturb the toner image carried on the intermediate transfer belt 131 and are conversely not fouled by toner or the like that residually adheres to the intermediate transfer belt 131. Although it is effective to provide the intermediate transfer belt 131 with a large winding angle in order to increase the effect of adjusting the tensile force imparted by the tension rollers, there is a structural problem in that when the tension rollers make contact with the image-carrying surface and an attempt is made to increase the winding angle, the surface of the intermediate transfer belt 131 must be endowed with a large negative curvature, and the toner image may possibly be affected. For these reasons, the tension rollers 133, 135 are arranged so as to be in contact with the reverse surface of the intermediate transfer belt 131.

In this embodiment, the belt drive roller 132 and the tension roller 133 are arranged so that the surface of the intermediate transfer belt 131 is in a substantially horizontal orientation from the downstream of the tension roller 133 to the upstream of the belt drive roller 132 in the belt movement direction D31. The primary transfer position TR1 of each image formation station is arranged on the same plane formed by the surface of the intermediate transfer belt 131 (more specifically, the lower surface to which the toner image is transferred). The movement direction of the rotating shaft of the tension roller 133 is also a substantially horizontal direction. Accordingly, the surface of the intermediate transfer belt 131 is kept horizontal even when the tension roller 133 has moved in order to absorb vibrations and speed fluctuations, and the effect on the image formation can be kept to a minimum. It is not essential that the surface of the intermediate transfer belt 131 be horizontal in the vicinity of the image formation stations, but it is preferred that at least the movement direction of the surface of the belt 131 and the movement direction of the tension roller 133 be the same or substantially the same.

The movement direction of the tension roller 135 is not limited in terms of image formation because the belt drive roller 132 is disposed between the tension roller and the primary transfer position TR1. In view of this fact, the speed fluctuations and vibrations of the intermediate transfer belt 131 can be most effectively reduced by making the tension roller move in a direction substantially orthogonal to the virtual plane tangent to the external peripheral surface of the belt drive roller 132 and the external peripheral surface of the secondary transfer backup roller 134.

A cleaner unit 139 configured to allow free contact with and separation from the surface of the intermediate transfer belt 131 is provided in the vicinity of the intermediate transfer body on which the tension roller 133 is wound. The cleaner unit 139 cleans the intermediate transfer belt 131 by sweeping off toner left behind on the surface of the intermediate transfer belt 131. The cleaner unit 139 is supported by a spring 331 in an integral fashion with the rotating shaft of the tension roller 133, and displaces in accompaniment with the displacement of the tension roller 133. Accordingly, the relative position between the cleaner unit 139 and the intermediate transfer belt 131 does not fluctuate.

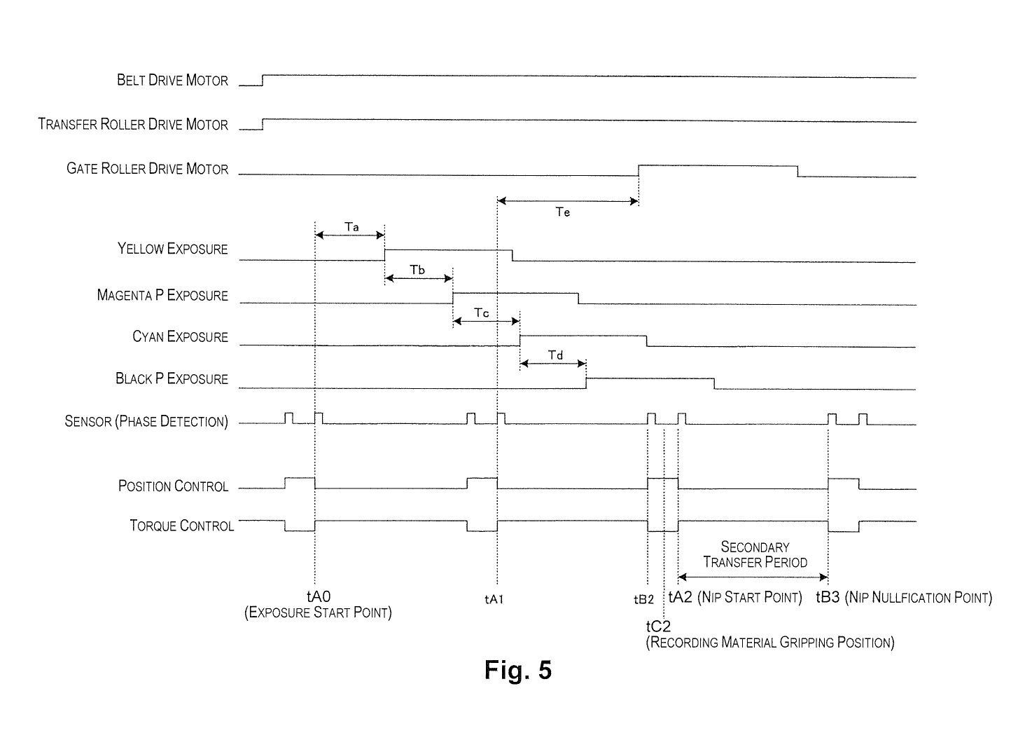

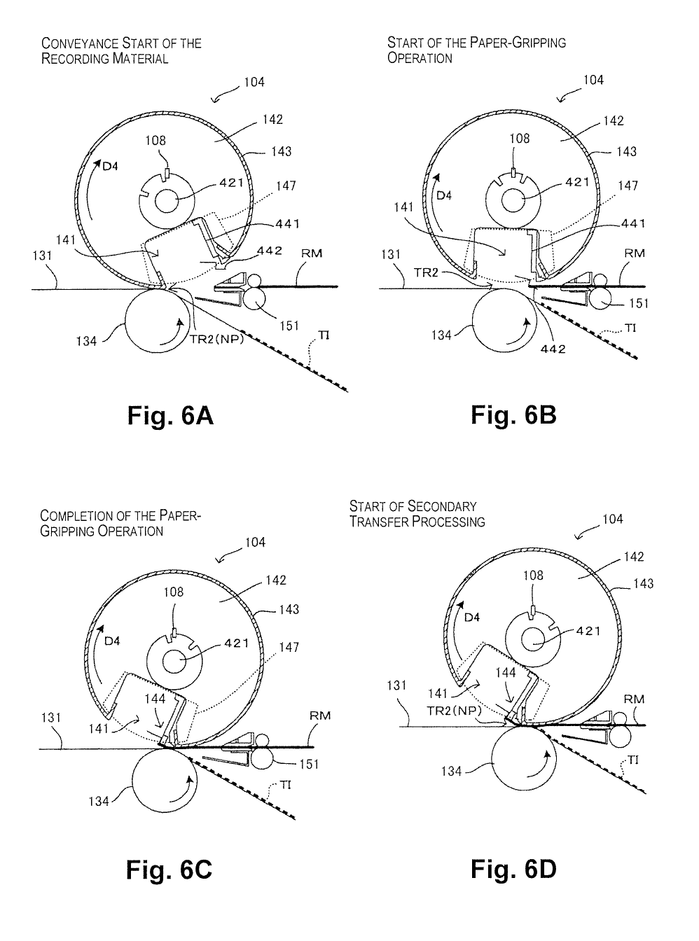

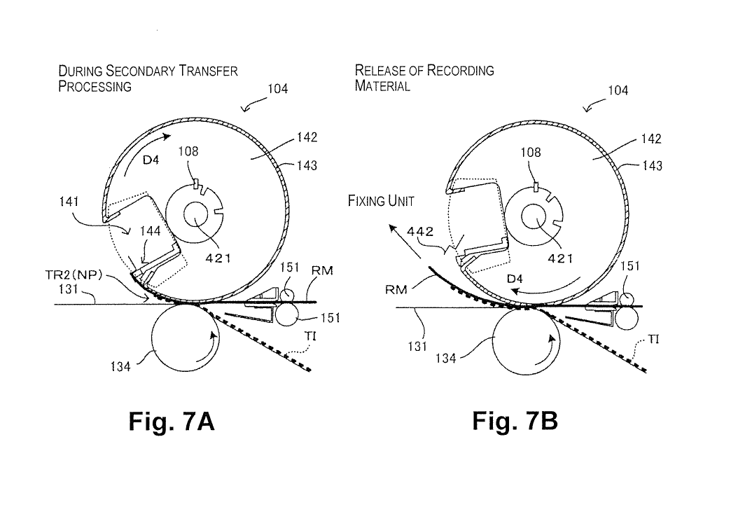

Next, the operation of the image formation apparatus 1 configured in the manner described above will be described with reference to FIGS. 5 to 7. FIG. 5 is a timing chart showing an operation example of the image formation apparatus of FIG. 1. FIGS. 6 and 7 are views that schematically show the operation of the image formation apparatus of FIG. 1. In the image formation apparatus 1, when an image formation command directing that a color image be formed is given to the controller 110 by a host computer or another external device, the controller 110 controls each component of the device in accordance with a program stored in memory (not shown). First, the belt drive motor M3 and the transfer roller drive motor M4 operate and drive the intermediate transfer belt 131 and the secondary transfer roller 104, respectively.

The phase detection sensor 108 (FIG. 2) provided to the secondary transfer roller 104 temporarily outputs a high (H) level signal when the surface of the secondary transfer roller 104 facing the intermediate transfer belt 131 in the secondary transfer position TR2 switches from the cylindrical peripheral surface having the elastic layer 143 to the recess part 141, and when the secondary transfer roller switches from the recess part 141 to the elastic layer 143. The controller 110 switches the drive control mode of the secondary transfer roller 104 implemented by the driver 112 between position control and torque control in alternating fashion on the basis of the change in the signal level. More specifically, position control is carried out when the recess part 141 of the secondary transfer roller 104 is facing the intermediate transfer belt 131, and torque control is carried out when the elastic layer 143 is facing the intermediate transfer belt 131 and the transfer nip NP is being formed. The belt drive motor M3 is constantly performing position control, and the surface of the intermediate transfer belt 131 moves in revolving fashion at a predetermined movement speed.

When the output of the phase detection sensor 108 changes at timing tA0, and the secondary transfer roller 104 facing the secondary transfer position TR2 changes from the recess part 141 to the elastic layer 143 to form a transfer nip NP, the controller 110 switches the drive control mode implemented by the driver 112 to torque control by using a control switch signal, and a command torque is given to the driver 112 to control the torque of the secondary transfer roller 104. The timing tA0 is used as the exposure starting point, a toner image is formed by the image formation stations 2Y, 2M, 2C, and 2K, and the toner image undergoes primary transfer to the surface of the intermediate transfer belt 131.

In other words, when time Ta has elapsed from timing tA0, latent image formation by the exposure unit 123 is started in the image formation station 2Y on the basis of various signals from the controller 110, and a toner image composed of yellow toner is formed, as shown in FIG. 5. Also, when time Tb has elapsed from the start of exposure for yellow, exposure for magenta is started; when time Tc has elapsed from the start of exposure for magenta, exposure for cyan is started; and when time Td has elapsed from the start of exposure for cyan, exposure for black is started. In this manner, the toner image of each color is formed and is sequentially superimposed on the intermediate transfer belt 131, and a full-color toner image TI is formed on the surface of the intermediate transfer belt 131.

The secondary transfer roller 104 rotates a single cycle in the rotational direction D4 while the toner image of each color is formed in this manner, and the momentarily nullified transfer nip NP is formed again. When a predetermined time Te has elapsed from the timing tA1, the controller 110 inputs a command pulse to the driver (not shown) that controls the gate roller drive motor (not shown) connected to the gate rollers 151 and causes the gate roller drive motor to operate. The conveyance of the recording material RM to the secondary transfer position TR2 is thereby initiated (FIG. 6(a)).

When secondary transfer roller 104 facing the secondary transfer position TR2 changes to the recess part 141 and the transfer nip is nullified, the controller 110 switches the drive control mode implemented by the driver 112 from torque control to position control by using the control switch signal at the timing tB2, and gives a command pulse to the driver 112. The secondary transfer roller 104 thereby rotates in the rotational direction D4 and moves to a predetermined recording medium gripping position (FIG. 6(b)). Also, the distal part of the gripper member 442 is made to move away from the distal end part of the gripper support member 441 to complete preparation for gripping the recording material RM. The distal end part of the recording material RM fed by the gate rollers 151 enters between the gripper member 442 and the gripper support member 441, and the paper-gripping operation is started (FIG. 6(b)).

The controller 110 gives a grip command to the gripper drive section (not shown) simultaneously to or slightly delayed from timing tB2. Having received the grip command, the gripper drive section operates and moves the distal end part of the gripper member 442 to the distal end part of the gripper support member 441. The distal end part of the recording material RM is thereby gripped and the “paper-gripping operation” is completed (FIG. 6(c)). At the point when the “paper-gripping operation” is completed, the toner image TI is positioned on the upstream side of the secondary transfer position TR2 in the movement direction D31 of the surface of the intermediate transfer belt 131, as shown in FIG. 6(c).

In this manner the recording material RM is conveyed in the rotational direction D4 together with the secondary transfer roller 104 while the distal end part of the recording material remains gripped by the gripping part 144. The recording material RM is held by the transfer nip NP between the elastic layer 143 of the secondary transfer roller 104 and the surface of the intermediate transfer belt 131 and is conveyed in accompaniment with the rotation thereof at the timing tA2 at which the elastic layer 143 on the surface of the secondary transfer roller 104 arrives at the secondary transfer position TR2 and the transfer nip NP begins formation. The secondary transfer of the toner image TI formed on the intermediate transfer belt 131 to the lower face (surface) of the recording material RM is thereby started (FIG. 6(d)). Also, at the timing tA2, the controller 110 switches the drive control mode implemented by the driver 112 to torque control by using the control switch signal, and gives command torque to the driver 112 to control the torque of the secondary transfer roller 104.

The secondary transfer roller 104 rotates in the rotational direction D4 while being torque-controlled in this manner, and in accompaniment therewith, the secondary transfer of the full-color toner image TI progresses with the recording material RM being passed between the transfer nip NP while the distal end part of the recording material is held by the gripping part 144 (FIG. 7(a)). When the gripping part 144 moves to a position near the upstream-side end part (right end-side end part of FIG. 1) of the conveyance roller 107, the distal end part of the recording material being held by the gripping part 144 is sufficiently separated from the intermediate transfer belt 131 and conveyed to the conveyance entrance of the conveyance roller 107. The controller 110 gives a release command to the gripper drive part at timing that occurs when the gripping part 144 has moved to the vicinity of the upstream-side end part of the conveyance roller 107, and moves the distal end part of the gripper member 442 away from the distal end part of the gripper support member 441 to release the grip on the recording material RM, as shown in FIG. 7(b). The distal end part of the recording material RM is thereby reliably sent to the conveyance roller 107 without sticking to the surface of the intermediate transfer belt 131. The color toner image TI is fused to the recording material RM by the fuser arranged behind the conveyance roller 107. After having been released, the distal end side of the recording material is conveyed to the fuser side along the conveyance path PT, and secondary transfer processing is carried out while the rear end side of the recording material RM is held at and conveyed the transfer nip NP by the intermediate transfer belt 131 and the elastic layer 143 of the secondary transfer roller 104.

As described above, in this embodiment, two tension rollers 133, 135 are disposed on the two sides of the secondary transfer position TR2 faced by the intermediate transfer belt 131 and the secondary transfer roller 104, which has the recess part 141 in a portion of the external peripheral surface, and are in contact with the intermediate transfer belt 131. Accordingly, the speed fluctuations and vibrations of the intermediate transfer belt 131, which are caused by load torque fluctuations when the surface of the secondary transfer roller 104 facing the secondary transfer position TR2 changes from the recess part 141 to the elastic layer 143 and conversely changes from the elastic layer 143 to the recess part 141, are alleviated by the two tension rollers 133, 135 and are prevented in advance from propagating to the primary transfer position TR1. For this reason, the toner image formed by the image formation stations 2Y, 2M, 2C, 2K in the primary transfer position TR1 is not disturbed by speed fluctuations or the like, and a good quality image can be formed in a stable manner.

In this embodiment, the image belt drive roller 132 is arranged outside of the pathway between the two tension rollers between which the secondary transfer position TR2 is positioned, more specifically, further upstream from the upstream-side tension roller 135 of the two tension rollers in the rotational direction D31 of the intermediate transfer belt 131 and further to the downstream side of the primary transfer position TR1k that corresponds to the image formation station 2K, which is the furthest downstream among the plurality of image formation stations. The belt drive roller 132 connected to the belt drive motor M3 and which has less speed fluctuation due to external causes is disposed between the tension roller 135 and the primary transfer position TR1k, thereby making it possible to more effectively suppress the propagation of speed fluctuations and the like of the intermediate transfer belt 131 at the secondary transfer position TR2 to the primary transfer position TR1k.

On the other hand, the effect of absorbing fluctuations by the belt drive roller is limited on the downstream side from the secondary transfer position TR2. For this reason, in this embodiment, the peripheral length from the secondary transfer position TR2 to the image formation station 2Y on the most upstream side along the belt pathway is made to be greater than the peripheral length from the secondary transfer position TR2 to the image formation station 2K on the most downstream side to increase the fluctuation-absorbing effect of the plasticity and elasticity of the belt itself, thereby suppressing the propagation of speed fluctuations and the like to the primary transfer position TR1y that corresponds to the image formation station 2Y on the most upstream side. The displacement direction of the tension roller 133 is furthermore made to be the same as or substantially the same as the stretch-out direction of the intermediate transfer belt 131 in the primary transfer position TR1y or the like, whereby displacement of the tension roller 133 is prevented from negatively affecting image formation.

### Second Embodiment

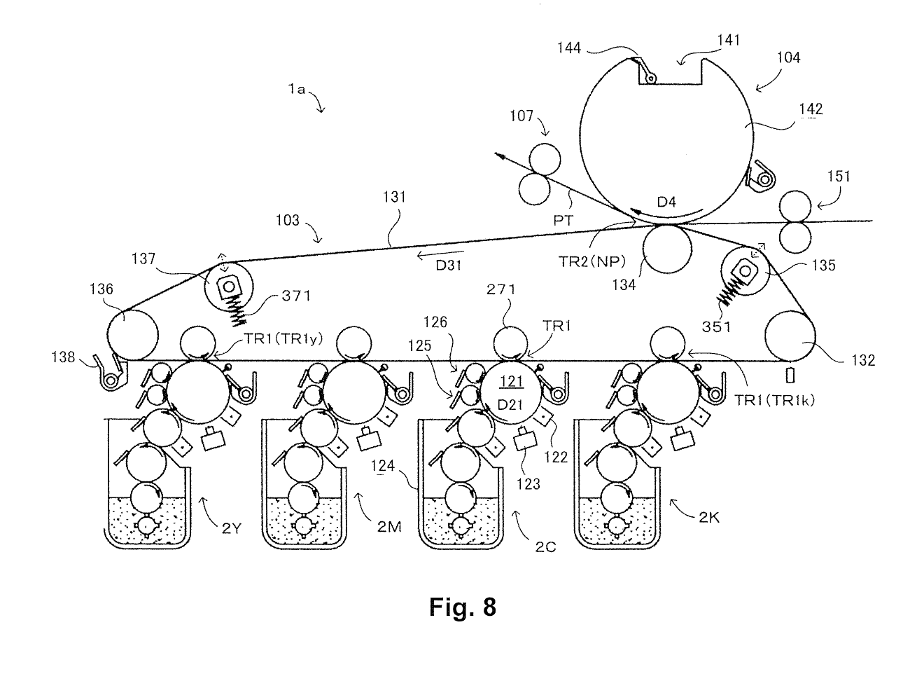

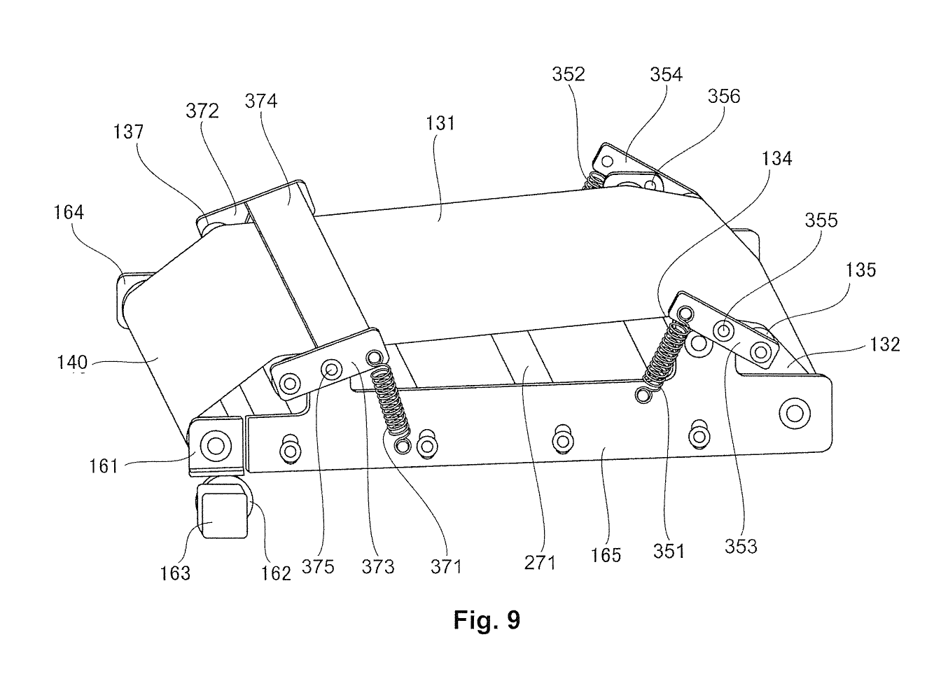

Next, a second embodiment of the image formation apparatus of the invention will be described with reference to FIGS. 8 and 9.

FIG. 8 is a view showing the second embodiment of the image formation apparatus according to the invention. FIG. 9 is a view for describing in detail the configuration of the transfer device in the second embodiment. In the first embodiment described above, the tension roller 133 is disposed in a position directly upstream from the most upstream-side image formation station 2Y. In contrast, in the image formation apparatus 1a of the second embodiment shown in FIG. 8, the steering roller 136 for adjusting the position of the intermediate transfer belt 131 in the width direction (the axial direction of the image belt drive roller) is disposed in a position directly upstream from the most upstream-side image formation station 2Y. Also, a tension roller 137 is disposed between the secondary transfer position TR2 and the steering roller 136. In other words, the structure has the addition of a steering roller 136 between the tension roller 137 disposed on the downstream side of the secondary transfer position TR2 in the movement direction D31 of the intermediate transfer belt 131, and the primary transfer position TR1 that corresponds to the image formation station 2Y on the most upstream side.

On end of the steering roller 136 (the far side in FIG. 9) is the secured end and the other end is the moving end (the near side in FIG. 9). The secured end is arranged on the far side of FIG. 9 and is rotatably secured and supported on the side plate 164 on which the image belt drive roller 132, the tension roller 135, and the tension roller 137 are supported. On the other hand, the moving end is supported by a frame 161 which is capable of moving in the vertical direction independent from the side plate 165 for supporting the image belt drive roller 132, the tension roller 135, and the tension roller 137 on the near side of FIG. 9, and the frame 161 moves vertically in accordance with the external peripheral profile of a cam 162 that is rotatably driven by a motor 163. The position of the intermediate transfer belt 131 in the width direction is thereby adjusted, and the image formed on the intermediate transfer belt 131 by the imaging station is prevented from being disturbed or becoming shifted from a predetermined range.

The tension roller 137 in the vicinity of the steering roller 136 is held at the two end parts by a frame 372 and a frame 373, and the frame is coupled by a coupling member 374; and provides stretching to the intermediate transfer belt 131 with the aid of two springs 371 disposed in positions with the tension roller 137 and a rotating support point 375 therebetween. In other words, the rotating shaft at the two ends of the tension roller 137 can move in the urging direction, but operates in complete coordination and cannot move independently.

A cleaner unit 138, which is configured to allow free contact with and separation from the surface of the intermediate transfer belt 131, is disposed in the vicinity of the intermediate transfer body wound around the steering roller 136, as shown in FIG. 8. The cleaner unit 138 cleans the intermediate transfer belt 131 by sweeping off toner left behind on the surface of the intermediate transfer belt 131. The cleaner unit 138 is supported in an integral fashion with the rotating shaft of the steering roller 136, and displaces in accompaniment with the displacement of the steering roller 136. Accordingly, the relative position between the cleaner unit 138 and the steering roller 136 does not fluctuate. Excluding these points, the configuration of the second embodiment is the same as that of the first embodiment described above. Therefore, the same reference numerals are used for the same configuration as the first embodiment, and a description is omitted.

In accordance with such a configuration, the fluctuation-absorbing effect of the two tension rollers 135, 137 makes it is possible to prevent the effect of speed fluctuations of the intermediate transfer belt 131 at the secondary transfer position TR2 from extending to the primary transfer position TR1 and disturbing image formation, in the same manner as the first embodiment described above. Also, the primary transfer position TR1 that corresponds to each image formation station 2Y and the like is positioned between the two rollers 132, 136 whose rotating shafts do not displace. Therefore, the orientation of the intermediate transfer belt 131 in each primary transfer position TR1 does not vary and image formation in each image formation station can be carried out in a stable manner. A steering roller 136 is disposed between the tension roller 137 and the primary transfer position TR1 that corresponds to the image formation station 2Y on the upstream side, thereby making it possible to reliably prevent the effect of displacement of the tension roller 137 from extending to the primary transfer position TR1y.

When there is variability in the pressing force in the axial direction of the intermediate transfer belt 131 in the secondary transfer position TR2, the temporary change in the tensile force of the intermediate transfer belt 131 due to speed fluctuations and vibrations becomes nonuniform in the width direction. This destabilizes the driving of the intermediate transfer belt 131, generates meandering and skewing, and reduces image quality.

However, in this embodiment, the rotating shafts at the two ends of the tension roller 135 are each capable of moving independently, and therefore operate to nullify the nonuniformity even when the tensile force variation of the intermediate transfer belt 131 is nonuniform in the width direction. Accordingly, the driving of the intermediate transfer belt 131 can be kept stable, and it is possible to suppress a reduction in the image quality due to meandering and skewing.

When a deflection angle generated by steering the steering roller 136 is propagated to the tension roller 137 through the intermediate transfer belt 131 as the medium, and a deflection angle is generated, and as a result, meandering and skewing (not shown) in the intermediate transfer belt 131 is generated and image quality is reduced.

However, in this embodiment, the rotating shafts at the two ends of the tension roller 137 can be moved in coordination with the urging direction. In other words, the deflection angle of the steering roller 136 propagates through the intermediate transfer belt 131 as the medium, and a deflection angle is not liable to be generated in the tension roller 137. A good quality image can thereby be formed on the recording material.

As described above, in these embodiments, the intermediate transfer belt 131 functions as the “image carrier” of the invention. Also, the belt drive roller 132, the secondary transfer backup roller 134, and the belt drive motor M3 function as the “drive roller,” the “backup roller,” and the “first drive source,” respectively, of the invention. The tension roller 135 in the first and second embodiments function as the “first tension roller” of the invention, and the tension roller 133 in the first embodiment and the tension roller 137 in the second embodiment both function as the “second tension roller” of the invention.

In the embodiments described above, the secondary transfer roller 104 and the motor M4 function as the “transfer roller” and the “second drive source,” respectively, of the invention. Also, the recess part 141 disposed in the secondary transfer roller 104 corresponds to the “notched portion” of the invention. The elastic layer 143 disposed on the peripheral surface of the secondary transfer roller 104, and the gripping part 144 function as the “elastic surface layer” and the “gripping mechanism,” respectively, of the invention.

In the embodiments described above, the image formation stations 2Y, 2M, 2C, and 2K each function as an “imaging station” of the invention, and these, as a unit, constitute the “imaging section” of the invention. Also, the primary transfer position TR1 that in each image formation station corresponds to the “imaging position” of the invention, and the primary transfer positions TR1k and TR1y corresponds to the “first imaging position” and the “second imaging position,” respectively, of the invention.

In the embodiments described above, the intermediate transfer belt 131, the belt drive roller 132, the secondary transfer backup roller 134, the secondary transfer roller 104, and the tension rollers 133, 135 and the like constitute, as a unit, the “transfer device” of the invention. These can be configured as a transfer unit detachable from the apparatus main body, and, in this case, the transfer unit corresponds to the “transfer device” of the invention. In this case, the drive sources for driving the transfer roller and drive roller are not required to be included in the transfer unit, and, for example, can be configured so as to function as drive sources by having the motors secured to the apparatus main body engage the transfer roller and the driver roller when mounted in the transfer unit.

The invention is not limited to the embodiments described above, and it is possible to make various modifications beyond those described above as long as such modifications do not depart from the spirit of the invention. For example, in the embodiments described above, four image formation stations are lined in a row along the stretch-out direction of the intermediate transfer belt 131, but the number and arrangement of the image formation stations are not limited thereto. For example, in the case that the invention is applied to an image formation apparatus provided with a single image formation station, the peripheral length of the belt to the transfer nip on the upstream side can be made to be greater than the peripheral length of the belt to the transfer nip on the downstream side in the rotational direction of the intermediate transfer belt 131 as viewed from the imaging position that corresponds to the image formation station.

In the embodiments described above, the image formation apparatus is a so-called developer scheme that uses a developer in which a toner is dispersed in a liquid carrier, but the application of the invention is not limited to such a scheme. In other words, regardless of the development scheme, the invention can be applied to image formation apparatuses and transfer devices in general that have a structure in which a transfer roller having a surface shape in which a portion of the cylindrical peripheral surface is notched is brought into contact with an intermediate transfer belt, as shown in FIG. 1.

The invention can also be applied to an apparatus provided with a transfer roller that does not have a gripping mechanism. For example, in an apparatus in which an elastic surface layer is configured by winding a sheet-shaped elastic body around the surface of the transfer roller, a notched part must be provided in the external peripheral surface of the transfer roller in order to secured the end parts of the sheet, but the invention can also be applied to an apparatus that has such a configuration and does not have a gripping mechanism.

### Third Embodiment

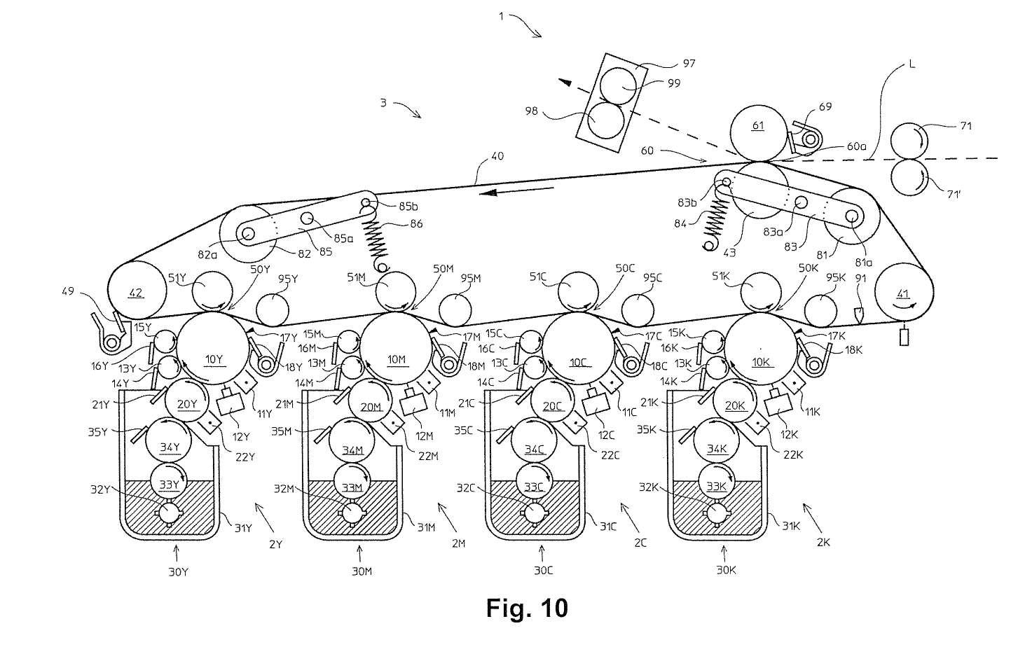

FIG. 10 is a view showing the main constituent elements constituting the image formation apparatus 1 according to a third embodiment of the invention. The image formation apparatus 1 mainly has image formation stations 2Y, 2M, 2C, and 2K and a transfer device 3.

The image formation apparatus 1 of this example is provided with image formation stations 2Y, 2M, 2C, and 2K having yellow (Y), magenta (M), cyan (C), and black (K) arranged horizontally or substantially horizontally in tandem, as shown in FIG. 10. The image formation stations 2Y, 2M, 2C, and 2K are provided with photoreceptors 10Y, 10M, 10C, 10K as image carriers. Electrostatic latent images of the colors Y, M, C, K are formed in corresponding fashion on and carried by the photoreceptors 10Y, 10M, 10C, 10K, respectively. The photoreceptors 10Y, 10M, 10C, 10K are each driven by drive motors (not shown) and are made to rotate in the arrowed direction (clockwise in FIG. 1) in FIG. 10. In the photoreceptors 10Y, 10M, 10C, 10K, in this case, 10Y represents a yellow photoreceptor, 10M represents a magenta photoreceptor, 10C represents a cyan photoreceptor, and 10K represents a black photoreceptor. Also, the same applies to the other members, and the colors Y, M, C, K are appended to the reference numerals of the members to represent the colors of the members.

Arranged around the periphery of the photoreceptors 10Y, 10M, 10C, 10K beginning with corona chargers 11Y, 11M, 11C, 11K as charging sections in the rotational direction around the external periphery of the photoreceptors 10Y, 10M, 10C, 10K are: exposure sections 12Y, 12M, 12C, 12K, which are line heads or the like; development rollers 20Y, 20M, 20C, 20K as developer carriers of developers 30Y, 30M, 30C, 30K; first photoreceptor squeeze rollers 13Y, 13M, 13C, 13K; second photoreceptor squeeze rollers 15Y, 15M, 15C, 15K; primary transfer sections 50Y, 50M, 50C, 50K; erase lamps 17Y, 17M, 17C, 17K as erasing sections; and photoreceptor cleaning blades 18Y, 18M, 18C, 18K. In the image formation process, in sequence from the corona chargers 11Y, 11M, 11C, 11K to the photoreceptor cleaning blades 18Y, 18M, 18C, 18K, a configuration arranged in a prior-occurring stage is defined to be upstream from a configuration arranged in a later-occurring stage.

First, the photoreceptors 10Y, 10M, 10C, 10K are uniformly charged by the corona chargers 11Y, 11M, 11C, 11K, exposure is carried out by the exposure sections 12Y, 12M, 12C, 12K on the basis of an inputted image signal, and an electrostatic latent image is formed on the charged photoreceptors 10Y, 10M, 10C, 10K.

The developers 30Y, 30M, 30C, 30K have: developer containers (reservoirs) 31Y, 31M, 31C, 31K for holding developer of each color composed of yellow (Y), magenta (M), cyan (C), and black (K); stirring rollers 32Y, 32M, 32C, 32K for stirring the developer of each color inside the developer containers 31Y, 31M, 31C, 31K; supply rollers 33Y, 33M, 33C, 33K and intermediate rollers 34Y, 34M, 34C, 34K as developer supply members for supplying the developer of each color from the developer containers 31Y, 31M, 31C, 31K to the development rollers 20Y, 20M, 20C, 20K; and intermediate roller-cleaning members 35Y, 35M, 35C, 35K for cleaning off the developer from intermediate rollers 34Y, 34M, 34C, 34K. The electrostatic latent image formed on the photoreceptors 10Y, 10M, 10C, 10K is developed by the developer of each color.

The developer stored in the developer containers 31Y, 31M, 31C, 31K is not a commonly used volatile developer that is volatile at normal temperature and that has low concentration (about 1 to 3 wt %) and low viscosity in which Isopar (registered trade name of Exxon) is used as the carrier fluid, but is rather a nonvolatile developer that is not volatile at normal temperature, and that has high concentration and high viscosity. In other words, the developer in the present embodiment is a developer in which solid particles obtained by dispersing a pigment or another colorant in a thermoplastic resin to achieve an average particle diameter of 1 μm are added together with a dispersant to a organic solvent, silicone oil, mineral oil, edible oil, or other liquid solvent, and which has high viscosity (as measured using a HAACKE RheoStress RS600 in which the viscosity is about 30 to 300 mPa·s at a sheer velocity of 1000 (1/s) at 25° C.) in which the toner solids content concentration is about 15 to 25%.

The development rollers 20Y, 20M, 20C, 20K have toner charge corona generators 22Y, 22M, 22C, 22K for toner charging the developer supplied to the periphery by the intermediate rollers 34Y, 34M, 34C, 34K and carried on the development rollers 20Y, 20M, 20C, 20K, and development roller-cleaning blades 21Y, 21M, 21C, 21K for cleaning the development rollers 20Y, 20M, 20C, 20K after the photoreceptors 10Y, 10M, 10C, 10K have been developed.

The development formed on the photoreceptors 10Y, 10M, 10C, 10K by the developer of each color has a portion of the carrier fluid squeezed away by the first photoreceptor squeeze rollers 13Y, 13M, 13C, 13K and the second photoreceptor squeeze rollers 15Y, 15M, 15C, 15K. First photoreceptor squeeze roller-cleaning members 14Y, 14M, 14C, 14K for cleaning away the carrier fluid thus squeezed are arranged at the periphery of the first photoreceptor squeeze rollers 13Y, 13M, 13C, 13K; and second photoreceptor squeeze roller-cleaning members 16Y, 16M, 16C, 16K for cleaning away the carrier fluid thus squeezed are arranged at the periphery of the second photoreceptor squeeze rollers 15Y, 15M, 15C, 15K.

An intermediate transfer belt 40 as the image-carrying belt is a belt formed using a seamless material composed of polyimide or other resin that is not liable to expand or contract due to tensile force. The intermediate transfer belt 40 is stretched around: the belt drive roller 41 as a first roller around which the intermediate transfer belt 40 is wound and which moves the intermediate transfer belt 40; a first tension roller 81 for imparting tensile force to the intermediate transfer belt 40, the intermediate transfer belt 40 being wound around the first tension roller and the intermediate transfer belt 40 being wound around the belt drive roller 41; a backup roller 43 as a second roller around which the intermediate transfer belt 40 is wound, the intermediate transfer belt being wound around the first tension roller 81; a second tension roller 82 for imparting tensile force to the intermediate transfer belt 40, the intermediate transfer belt 40 being wound around the second tension roller and the intermediate transfer belt 40 being wound around the backup roller 43; and a stretch-out roller 42 around which the intermediate transfer belt 40 is wound, the intermediate transfer belt being wound around the second tension roller 82. The belt drive roller 41 is driven by a belt drive roller drive section (not shown).

The intermediate transfer belt 40 is in contact with the photoreceptors 10Y, 10M, 10C, 10K in the primary transfer sections 50Y, 50M, 50C, 50K. The primary transfer sections 50Y, 50M, 50C, 50K are arranged so that primary transfer rollers 51Y, 51M, 51C, 51K and the photoreceptors 10Y, 10M, 10C, 10K face each other with the intermediate transfer belt 40 disposed therebetween. Winding rollers 95Y, 95M, 95C, 95K are arranged between the primary transfer rollers 51Y and 51M, 51M and 51C, 51C and 51K, and 51K and the belt drive roller, respectively, and the intermediate transfer belt 40 is stretched further to the photoreceptor side than an imaginary line that passes through the contact position with the primary transfer roller of the primary transfer section of the photoreceptors 10Y, 10M, 10C, 10K via the intermediate transfer belt, and is wound on the photoreceptors 10Y, 10M, 10C, 10K to form an arcuate nip. It is thereby possible to obtain good transfer efficiency in the case that development is carried out with the high-concentration, high-viscosity developer used in the invention.

Using the position in which the photoreceptors 10Y, 10M, 10C, 10K and the intermediate transfer belt 40 are in contact as the primary transfer position, the toner image of each color on the developed photoreceptors 10Y, 10M, 10C, 10K is sequentially overlaid and transferred onto the intermediate transfer belt 40 to form a full-color toner image.

On the other hand, in the case that a monochrome toner image is to be formed on the intermediate transfer belt 40, image formation is carried out in a state in which the photoreceptors of the other colors are set at a distance from the intermediate transfer belt 40. For example, in the case that a black toner image is to be formed on the intermediate transfer belt 40, image formation is carried out in a state in which the yellow, magenta, and cyan photoreceptors are set at a distance from the intermediate transfer belt 40. The contact/separation operation of the photoreceptors is carried out by a photodetector contact/separation mechanism (not shown).

A transfer belt-cleaning blade 49 as the image-carrying belt-cleaning member makes contact in a location where the intermediate transfer belt 40 is stretched around the stretch-out roller 42, and the remaining toner and carrier fluid on the intermediate transfer belt 40 is cleaned away.

A detection mark 40a is disposed on the inner side of the intermediate transfer belt 40, and a belt position sensor 91 detects the detection mark 40a.

The developer remaining on the photoreceptors 10Y, 10M, 10C, 10K after primary transfer to the intermediate transfer belt 40 is erased by the erase lamps 17Y, 17M, 17C, 17K, which function as image carrier-cleaning members, and is cleaned away by the photoreceptor cleaning blades 18Y, 18M, 18C, 18K as image carrier-cleaning members.

In a secondary transfer section 60, a secondary transfer roller 61 is a transfer roller to which a transfer bias is applied and that is rotated by a transfer roller drive section (not shown) in the direction shown by the arrow. The secondary transfer roller makes contact with the backup roller 43 via the intermediate transfer belt 40 to form a transfer nip, and transfers the toner image on the intermediate transfer belt 40 to a form paper, film, cloth, or other transfer material conveyed on the transfer material conveyance path L.

A transfer roller-cleaning blade 69 as a transfer roller-cleaning member furthermore makes contact with the peripheral surface of the secondary transfer roller 61 and cleans away the toner and carrier fluid transferred to the peripheral surface of the secondary transfer roller 61, whereby fouling of the reverse surface of the transfer material can be reduced.

A transfer material conveyance section (not shown) is arrayed downstream from the secondary transfer section 60 in the transfer material conveyance path L, and is arranged so as to convey the transfer material to a fixing unit 97. In the fixing unit 97, the transfer material is inserting through the nip between a heating roller 98 and a pressure roller 99 urged to the heating roller side with a predetermined pressure, whereby the monochrome toner image or the full-color toner image transferred onto the form paper or other transfer material is fused and fixed to the form paper or other transfer material.

The transfer material fed to the image formation apparatus is set in a paper feed device (not shown). The transfer material set in the paper feed device is sent out to the transfer material conveyance path L one sheet at a time with predetermined timing. In the transfer material conveyance path L, the transfer material is conveyed to the second transfer position by a pair of gate rollers 71, 71′ as the transfer material-forwarding section, and the toner image formed on the intermediate transfer belt 40 is transferred to the transfer material. The gate roller 71 is driven by a drive source (not shown).

The arrangement sequence of the image formation stations 2Y, 2M, 2C, and 2K that correspond to the Y, M, C, K is not limited to the example shown in FIG. 10 and can be set arbitrarily.

Next, the configuration of the transfer device 3 of the third embodiment will be described in detail.

The transfer device 3 has a primary transfer section 50 and a secondary transfer section 60, as shown in FIG. 10. The intermediate transfer belt 40 receives the transfer of an image from the photoreceptors 10Y, 10M, 10C, 10K in the primary transfer section 50, and transfers the image to the transfer material in the secondary transfer section 60.

The intermediate transfer belt 40 is stretched around the belt drive roller 41, the stretch-out roller 42, the backup roller 43, the first tension roller 81, and the second tension roller 82.

The first tension roller 81 is arranged in a position located after a predetermined position of the intermediate transfer belt 40, while making a single cycle, has passed by the belt drive roller 41 but has yet to advance onto the backup roller 43. In other words, the first tension roller 81 is arranged in front of a secondary transfer section 60a in terms of the movement direction of the intermediate transfer belt 40.

The second tension roller 82 is arranged in a position located after a predetermined position of the intermediate transfer belt 40, while making a single cycle, has passed by the backup roller 43 but has yet to advance onto stretch-out roller 42. In other words, the second tension roller 82 is arranged behind the secondary transfer section 60a in terms of the movement direction of the intermediate transfer belt 40.

The first tension roller 81 is disposed so as to be capable of rotation about the rotating shaft 81a of the first tension roller. The rotating shaft 81a of the first tension roller is supported by a first tension roller support lever 83 as a first tension roller support member. The first tension roller support lever 83 is rotatably supported by the first lever support shaft 83a on a frame, a case, or the like (not shown) of the image formation apparatus 1. Also, the first tension roller support lever 83 has a first spring attachment section 83b on the side opposite from the rotating shaft 81a of the first tension roller in relation to the first lever support shaft 83a. One of ends of first springs 84 is attached to the first spring attachment section 83b.

The second tension roller 82 is disposed so as to be capable of rotation about the rotating shaft 82a of the second tension roller. The rotating shaft 82a of the second tension roller is supported by a second tension roller support lever 85 as a second tension roller support member. The second tension roller support lever 85 is rotatably supported by a second lever support shaft 85a on a frame, a case, or the like (not shown) of the image formation apparatus 1. Also, the second tension roller support lever 85 has a second spring attachment section 85b on the side opposite from the rotating shaft 82a of the second tension roller in relation to the second lever support shaft 85a. One of a pair of second springs 86 is attached to the second spring attachment section 85b, and the other of the pair of second springs 86 is supported by a frame, a case, or the like (not shown).

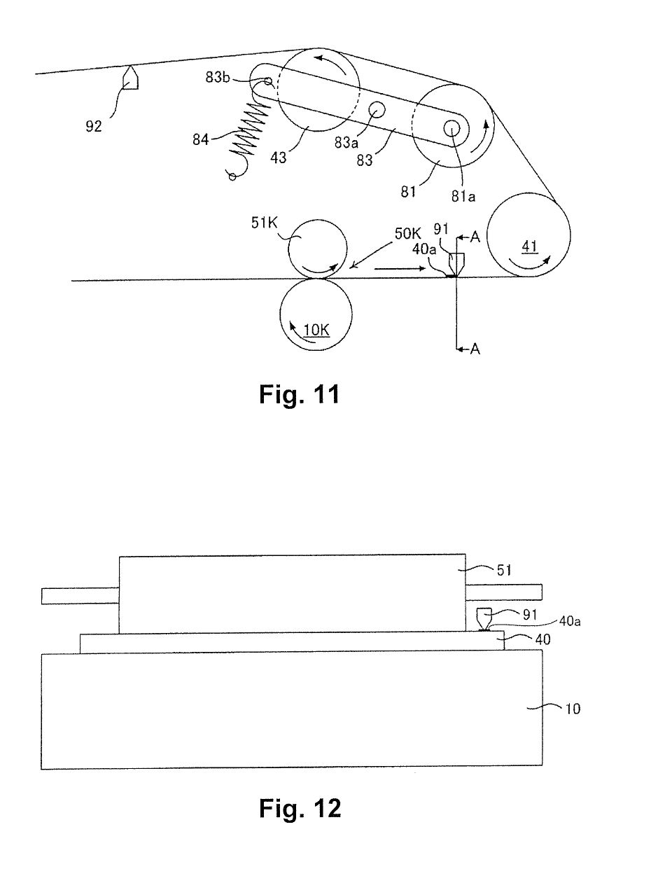

FIG. 11 is a view showing the state in which the belt position sensor 91 detects the detection mark 40a of the intermediate transfer belt 40, and FIG. 12 is a view of the cross section A-A of FIG. 11 as seen from the arrow direction.

The belt position sensor 91 is arranged behind the black primary transfer section 50K in terms of the rotational direction of the intermediate transfer belt 40, and in front of the belt drive roller 41 in terms of the rotational direction of the intermediate transfer belt 40, as shown in FIG. 11. Also, the belt position sensor 91 is arranged inside the trajectory of the intermediate transfer belt 40, the trajectory being formed by the surface on the side opposite from the surface on which the image is carried, as shown in FIG. 12.

Next, the operation for switching image formation modes will be described using an example in which a switch is made from the full-color image formation mode to the black monochrome image formation mode.

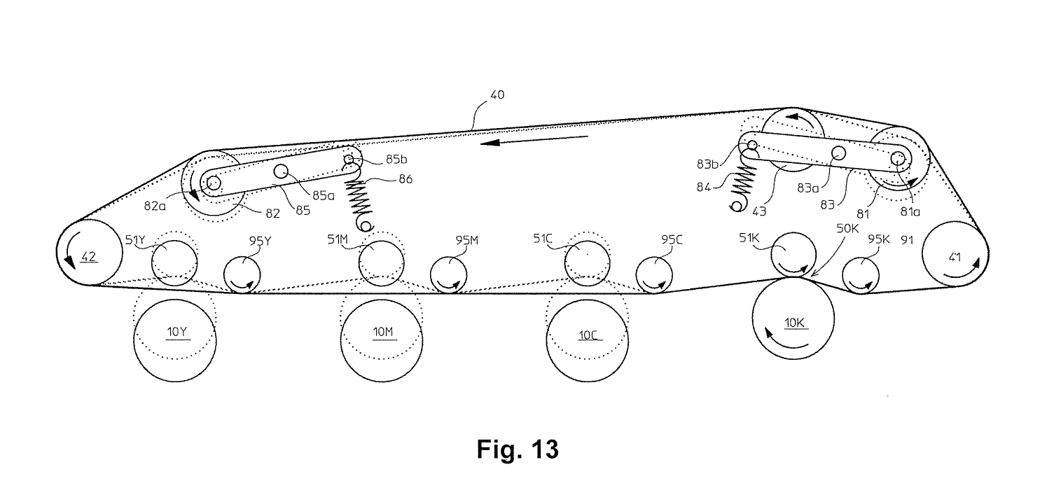

FIG. 13 is a view showing the state of transfer device 3 and the photoreceptors 10Y, 10M, 10C, 10K of the third embodiment in the full-color image formation mode and the black monochrome image formation mode. The broken line shows the full-color mode state and the solid line shows the black monochrome mode state.

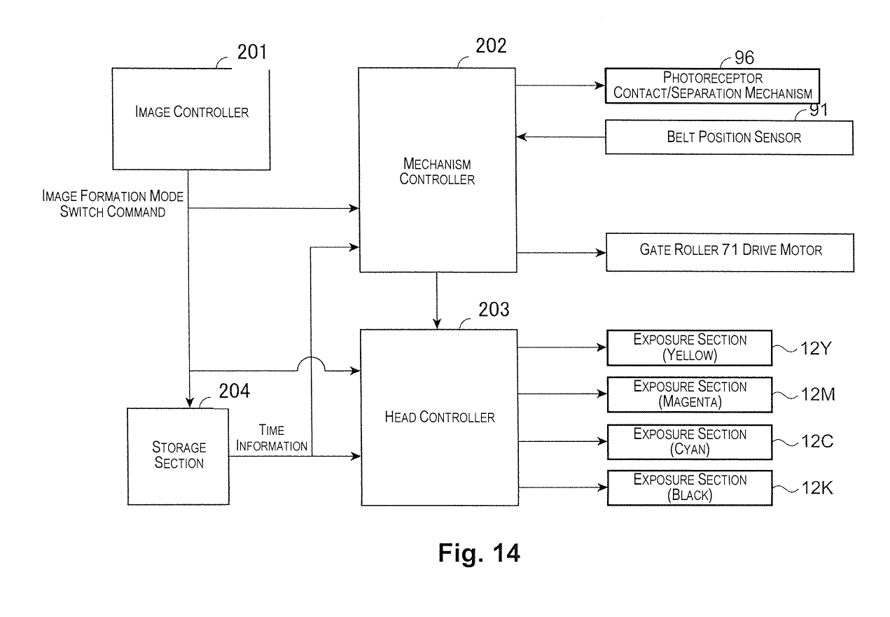

FIG. 14 is a block view of the control system according to the present third embodiment.

When an image formation mode switch command is send from an image controller 201 to a mechanism controller 202, a photoreceptor contact/separation mechanism 96 operates and the photoreceptors 10Y, 10M, 10C, 10K are set at a distance from the intermediate transfer belt 40. The photoreceptor 10K is thereafter again brought into contact with the intermediate transfer belt 40. At this time, the state in which the intermediate transfer belt 40 is wound around the photoreceptors 10Y, 10M, 10C in the primary transfer sections 50Y, 50M, 50C no longer exists and the conveyance path of the intermediate transfer belt 40 in the black monochrome image formation mode is shorter between the stretch-out roller 42 and the photoreceptor 10K in comparison with the full-color image formation mode. On the other hand, the changed distance due to the shorter path between the stretch-out roller 42 and the photoreceptor 10K is absorbed when the position of the first tension roller 81 and the second tension roller 82 change, and a state is produced in which the path of the intermediate transfer belt 40 has been increased between the belt drive roller 41 and the secondary transfer section 60.

Next, the control method for switching the light-emission timing of the exposure sections 12Y, 12M, 12C, 12K in accordance with the image formation mode, and matching the timing at which the toner image carried on the intermediate transfer belt 40 enters into the secondary transfer section 60 and the timing at which the transfer material enters the secondary transfer section 60.

In the present embodiment, the light-emission timing of the exposure sections 12Y, 12M, 12C, 12K and the operation timing of the gate roller 71 are controlled using as a reference signal the detection signal of the belt position sensor 91 for detecting the detection mark 40a disposed on the inner side of the intermediate transfer belt 40.

The information about the time from when the reference signal is detected until the exposure sections 12Y, 12M, 12C, 12K begin emitting light is stored for each image formation mode in a storage section 204, and is sent to a head controller 203 on the basis of the image formation mode switch command outputted from the image controller 201. In the head controller 203, the light-emission start time of the exposure sections 12Y, 12M, 12C, 12K is controlled on the basis of the time information thus received.

The paper feed operation of the gate roller 71 is controlled on the basis of the time information stored in the storage section 204 after the reference signal has been detected, and the time information is the same regardless of the image formation mode.

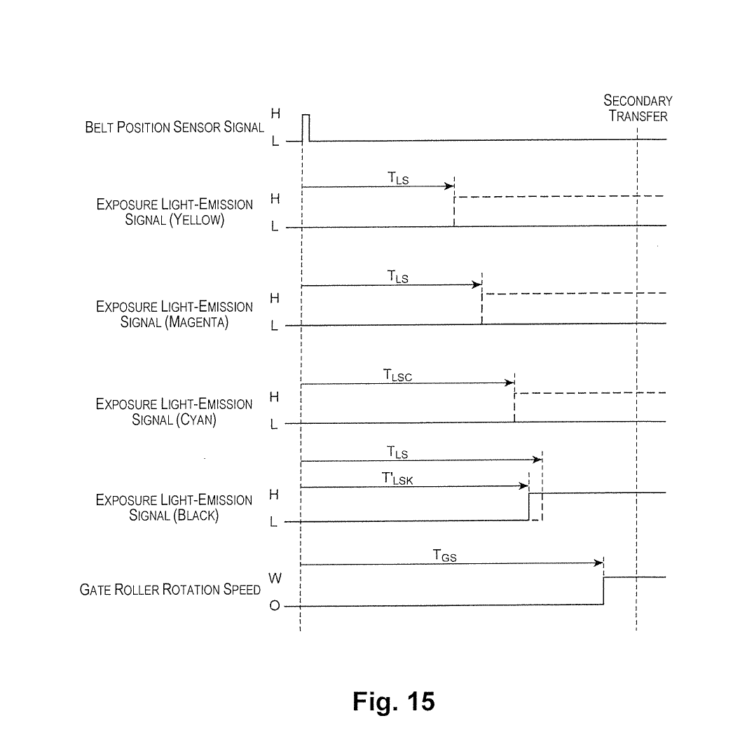

FIG. 15 is a timing chart of the light-emission of the exposure sections 12Y, 12M, 12C, 12K and the rotatable operation of the gate roller 71. The broken line shows the timing of the full-color mode and the solid line shows the timing of the black monochrome mode.

In FIG. 15, T_{LSY}, T_{LSM}, T_{LSC}, T_{LSK} are the times that start when the reference signal is detected and end when the exposure sections 12Y, 12M, 12C, 12K emit light and begin to form a latent image; the time T_{LSK} is the light-emission start time of the exposure section 12K in the full-color image formation mode; T′_{LSK} is the light-emission start time of the exposure section 12K in the black monochrome image formation mode; and T_{GS} is the time that starts from when the reference signal is detected and ends when the gate roller 71 starts rotatably operating.

In the image formation apparatus 1 of the present embodiment, the movement time of the intermediate transfer belt 40 from the primary transfer section 50K to the secondary transfer section 60 in the full-color image formation mode is 1.74 seconds, the movement time of the intermediate transfer belt 40 from the primary transfer section 50K to the secondary transfer section 60 in the black monochrome image formation mode is 1.78 seconds, and the time between the start of gate roller 71 operation and the entry of the transfer material into the secondary transfer section 60 is 0.65 seconds, in the case that the process speed is 250 mm/s, the photoreceptor diameter is 78 mm, the photoreceptor rotational angle from the exposure position to the primary transfer position is 180 degrees, the length of the intermediate transfer belt 40 from the primary transfer section 50K to the secondary transfer section 60 in the full-color image formation mode is 436.1 mm, the length of the intermediate transfer belt 40 from the primary transfer section 50K to the secondary transfer section 60 in the black monochrome image formation mode is 444.9 mm, and the transfer material conveyance distance from the gate roller 71 to the secondary transfer section 60 is 161.4 mm.

Stored in the storage section 204 are an exposure start time T_{LSK} of 6.70 seconds of the exposure section 12K in the full-color image formation mode, an exposure start time T′_{LSK} of 6.66 seconds of the exposure section 12K in the black monochrome image formation mode, and a time T_{GS} of 8.29 seconds at which the gate roller 71 starts rotational operation.

In the case that a switch has been made from the full-color image formation mode to the black monochrome image formation mode, the exposure start time information of the exposure section 12K to be sent to the head controller 203 is switched from T_{LSK} to T′_{LSK}. On the other hand, the gate roller 71 starts operation after a time T_{GS} of 8.29 seconds, which is the same as the full-color image formation mode.

As described above, in the case that a switch has been made from the full-color image formation mode to the black monochrome image formation mode and the distance from the primary transfer section to the secondary transfer section has changed, an image can be transferred in a suitable position on the transfer material and an image with stable margins on the transfer material can be obtained because the exposure section switches the time at which light-emission is to start, whereby the timing at which the toner image carried on the intermediate transfer belt 40 enters into the secondary transfer nip 60 and the timing at which the transfer material enters the secondary transfer nip 60 are matched without changing the timing at which the transfer material is conveyed.

### Fourth Embodiment

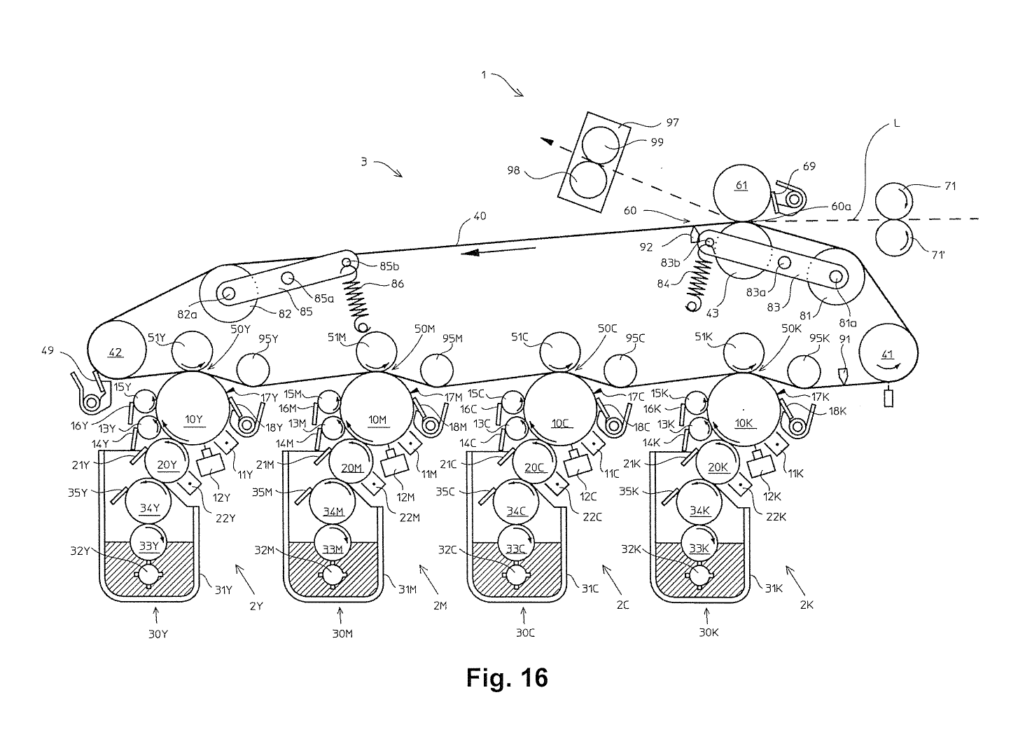

The configuration of the image formation apparatus 1 of the fourth embodiment shown in FIG. 16 will be described. In the fourth embodiment, a second belt position sensor 92 as a second detector is disposed in addition to the first belt position sensor 91 as a detector for detecting the detection mark 40a disposed on the inner side of the intermediate transfer belt 40. Except for the configuration of the second belt position sensor 92, the device configuration is otherwise the same as the device configuration of the third embodiment.

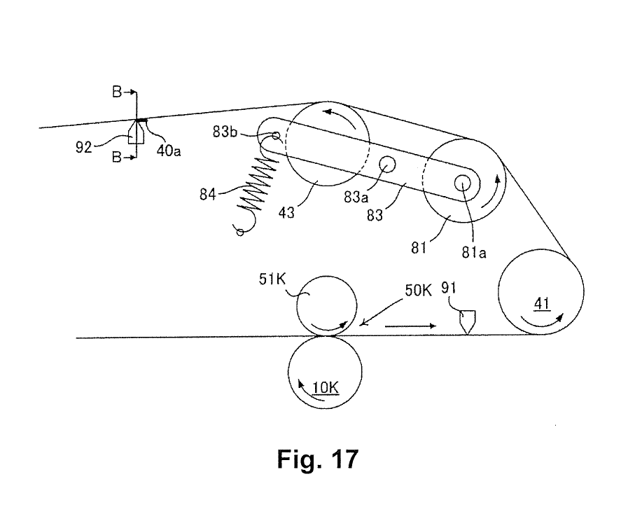

FIG. 17 is a view showing the state in which the second belt position sensor 92 detects the detection mark 40a of the intermediate transfer belt 40.

The second belt position sensor 92 is arranged downstream of the backup roller 43 in terms of the rotational direction of the intermediate transfer belt 40, and upstream of the second tension roller 82 (not shown) in terms of the rotational direction of the intermediate transfer belt 40, as shown in FIG. 17.

The time required for the intermediate transfer belt 40 to move from the primary transfer section to the secondary transfer section, i.e., the time required for the toner image carried on the intermediate transfer belt 40 to arrive at the secondary transfer section 60 can be known by detecting the movement time between belt position sensors, which is the movement time of the intermediate transfer belt 40 after the mark 40a of the intermediate transfer belt 40 has been detected by the belt position sensor 91 until the mark 40a is detected by the second belt position sensor 92.

The method for correcting the light-emission start time of the exposure section on the basis of the movement time of the intermediate transfer belt 40 between belt position sensors will be described.

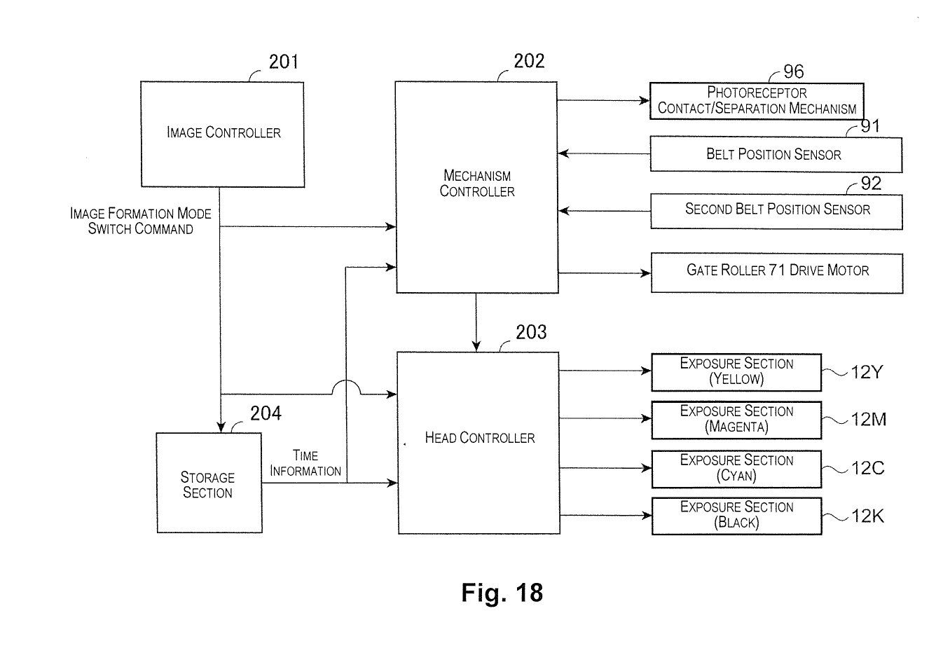

FIG. 18 is a block view of the control system according to the fourth embodiment.

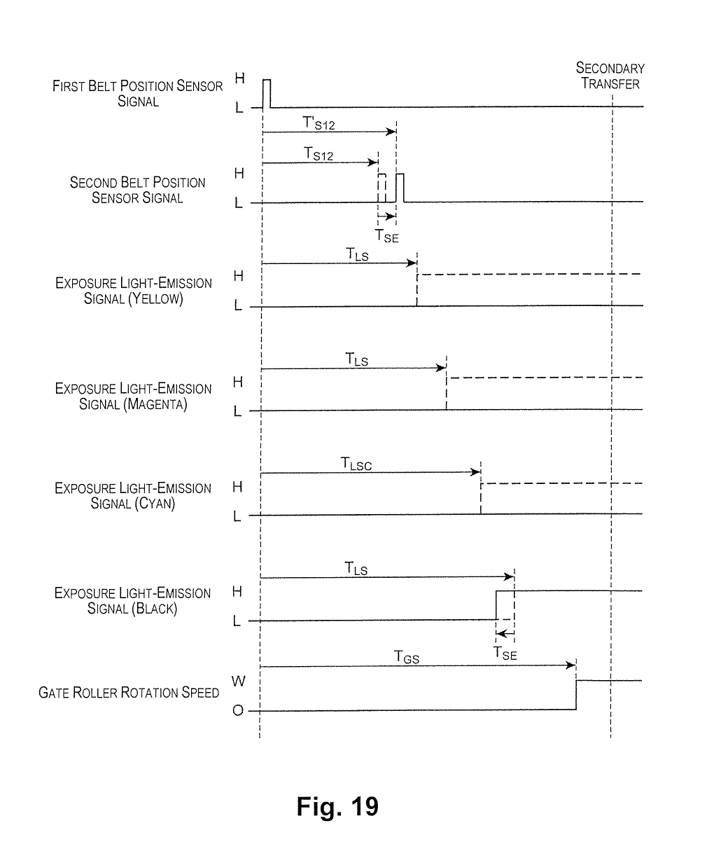

FIG. 19 is a timing chart of the light-emission of the exposure sections 12Y, 12M, 12C, 12K and the rotatable operation of the gate roller 71 according to the fourth embodiment. The broken line shows the full-color mode and the solid line shows the black monochrome mode.

In FIG. 19, T_{LSY}, T_{LSM}, T_{LSC}, T_{LSK} are the times that start when the reference signal is detected and end when the exposure sections 12Y, 12M, 12C, 12K emit light and begin to form a latent image; T_{GS} is the time that starts from when the reference signal is detected and ends when the gate roller 71 starts rotatably operating. T_{LSY}, T_{LSM}, T_{LSC}, T_{LSK}, and T_{GS} are stored in the storage section 204 as time information set that has been in advance. T_{S12} is the movement time between belt position sensors that is set in advance and stored in the storage section 204. T′_{S12} is the movement time between belt position sensors from actual measurement. T_{SE} is the time difference between T_{S12} and T′_{S12}.

In the case that the movement time T′_{S12} between belt position sensors actually measured is greater than the movement time T_{S12} between belt position sensors stored in the storage section 204, the light-emission of the exposure section 12K is corrected to be T_{SE} earlier than T_{LSK} stored in the storage section 204.

In the present embodiment, a correction is made to the light-emission start time of the exposure section that is based on the movement time of the intermediate transfer belt 40 between belt position sensors, in the case that T_{S12} is 1.80 seconds as the movement time between belt position sensors in the full-color image formation mode, T′_{LSK} is 6.70 seconds as the light-emission start time of the exposure section 12K in the full-color image formation mode, and a switch has been made from the full-color image formation mode to the black monochrome image formation mode.

The movement time T′_{S12} between belt position sensors that was actually measured in the black monochrome image formation mode was 1.84 seconds, and the movement time T_{S12} between belt position sensors in the black monochrome image formation mode was calculated to be 0.04 seconds. In view of this, the light-emission of the exposure section 12K is started 0.04 seconds earlier than the T_{LSK}, and the formation of a latent image on the photoreceptor 10K is started. On the other hand, the gate roller 71 begins operation 8.29 seconds later, which time T_{GS} and is the same as the full-color image formation mode. At this point, the timing at which the toner image carried on the intermediate transfer belt 40 enters into the secondary transfer nip 60 is the same time as the case of the full-color image formation mode, and can be accurately matched to the timing at which the transfer material enters the secondary transfer nip 60.

In this manner, the light-emission start time of the exposure section is corrected on the basis of the movement time between belt position sensors actually measured, whereby an image can be transferred in a suitable position on the transfer material and an image with stable margins on the transfer material can be obtained, even in the case that a switch has been made from the full-color image formation mode to the black monochrome image formation mode and the distance from the primary transfer section to the secondary transfer section has changed.

### Fifth Embodiment

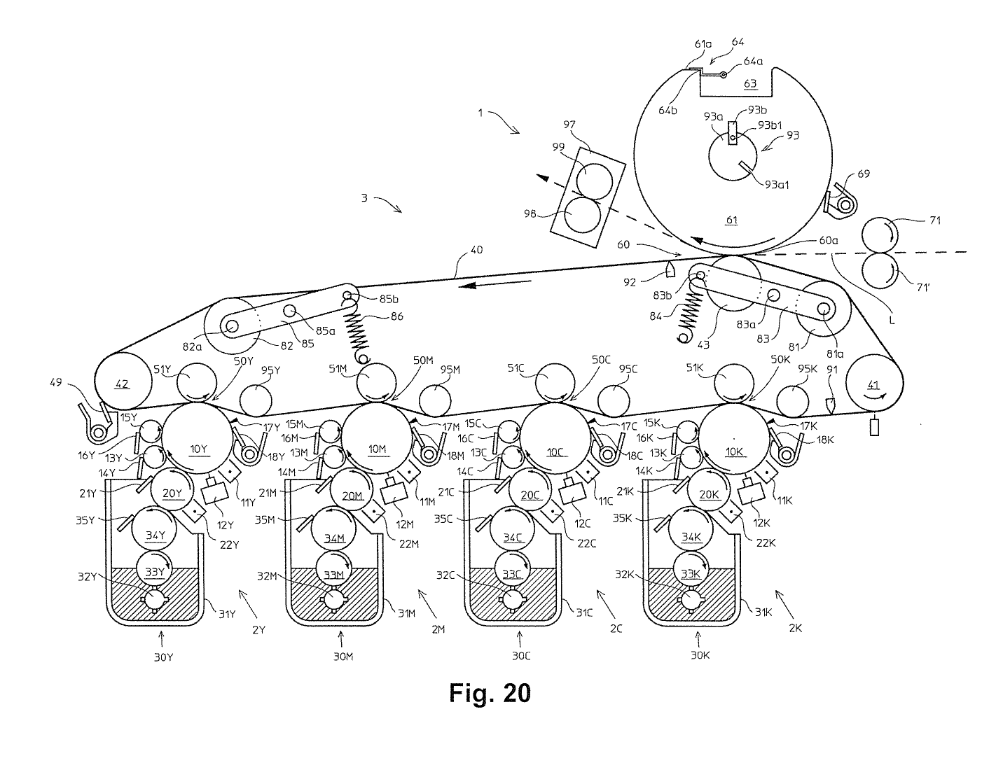

FIG. 20 shows the configuration of the image formation apparatus 1 according to a fifth embodiment. In the fifth embodiment, the secondary transfer roller 61 has a recess part 63 formed in the roller peripheral surface, and a gripping member 64 for gripping the distal end of the transfer material during secondary transfer is disposed in the recess part 63. The gripping member 64 can be rotated about a rotating shaft 64a, and rotates to a state in which the transfer material abuts against an abutment 64b to grip the transfer material together with a gripping member support section 61a of the secondary transfer roller 61. The secondary transfer roller 61 is driven by a drive source (not shown) and the transfer material in a gripped state is fed into the secondary transfer section 60. Excluding the secondary transfer roller 61, the configuration of the device is the same as the configuration of the fourth embodiment.

The presence of the gripping member 64 can reduce the sticking of the transfer material to the intermediate transfer belt 40 in the case that a high-concentration, high-viscosity, nonvolatile developer that is nonvolatile at normal temperature is used. Furthermore, the precision of the position in which the transfer material contacts the intermediate transfer belt can be improved by having a transfer material abutment 64b.

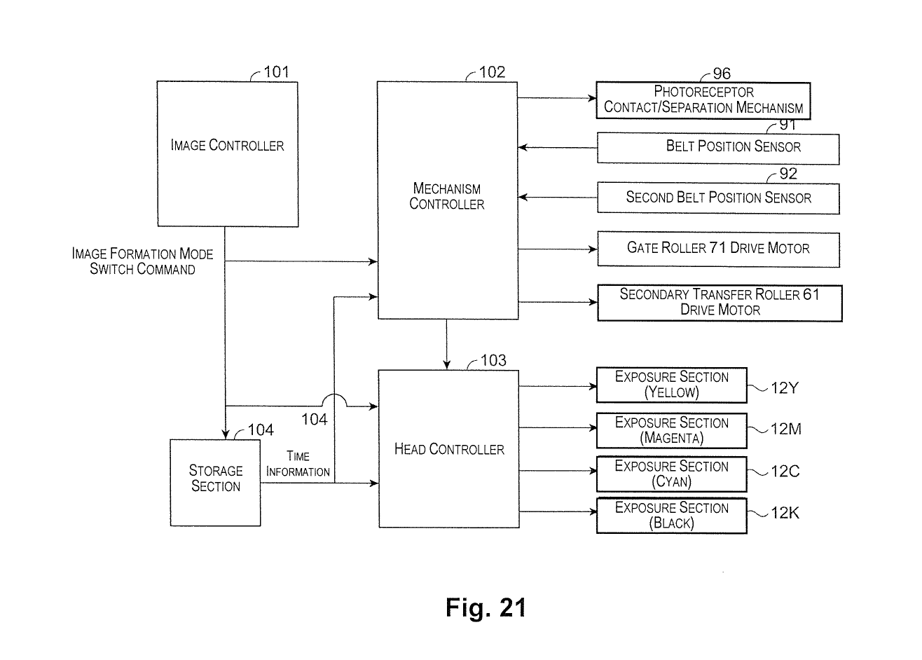

FIG. 21 is a block view of the control system according to the fifth embodiment.

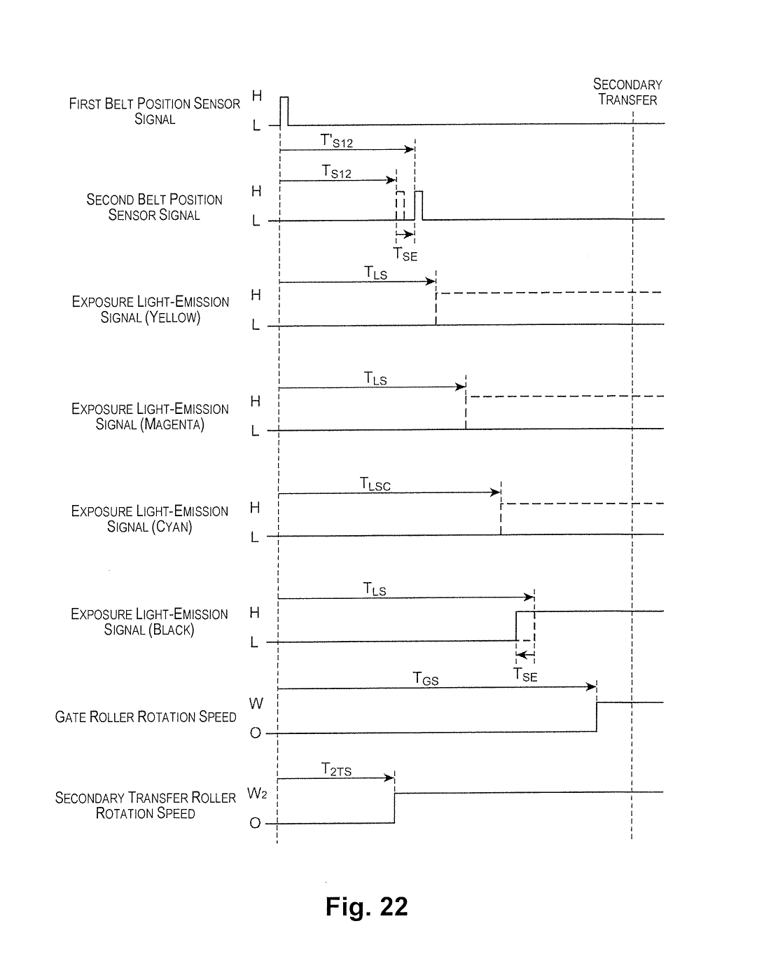

FIG. 22 is a timing chart of the light-emission of the exposure sections 12Y, 12M, 12C, 12K, the rotatable operation of the gate roller 71, and the rotatable operation of the secondary transfer roller 61 according to the fifth embodiment. The broken line shows the full-color mode and the solid line shows the black monochrome mode.

In FIG. 22, T_{LSY}, T_{LSM}, T_{LSC}, T_{LSK} are the times that start when the reference signal is detected and end when the exposure sections 12Y, 12M, 12C, 12K emit light and begin to form a latent image; T_{GS} is the time that starts from when the reference signal is detected and ends when the gate roller 71 starts rotatably operating; and T_{2TS} is the time that starts from when the reference signal is detected and ends when the secondary transfer roller 61 starts rotatably operating. T_{LSY}, T_{LSM}, T_{LSC}, T_{LSK}, T_{GS}, and T_{2TS} are stored in the storage section 204 as time information set that has been in advance. T_{S12} is the movement time between belt position sensors that stored in the storage section 204; T′₁₂ is the movement time between belt position sensors from actual measurement; and T_{SE} is the time difference between T_{S12} and T′_{S12}.

When an image formation mode switch command is sent from the image controller 201, the secondary transfer roller 61 is stopped after a time set in advance has elapsed after a home position 93 is detected. At this time, the recess part 63 formed in the roller peripheral surface of the secondary transfer roller 61 is positioned in the secondary transfer section 60, and the intermediate transfer belt 40 and the roller surface of the secondary transfer roller 61 are in a state set at a distance from each other.

When the belt position sensor 91 detects the mark 40a of the intermediate transfer belt 40, the secondary transfer roller 61 begins to rotatably operate T_{2TS} later at a constant rotational speed set in advance.

In the present embodiment, the secondary transfer roller has a diameter of 190 mm and a recess part angle of 57.3 degrees, the rotational angle from the stop position to the secondary transfer section is 50 degrees, and the time T_{2TS} at which the secondary transfer roller 61 begin rotational operation is set to 1.44 seconds.

The light-emission start time of the exposure section that is based on the movement time of the intermediate transfer belt 40 between belt position sensors is corrected in the case that T_{S12} is 1.80 seconds, which is the movement time between belt position sensors in the full-color image formation mode, T_{LSK} is 6.70 seconds, which is the light-emission start time of the exposure section 12K in the full-color image formation mode, and a switch has been made from the full-color image formation mode to the black monochrome image formation mode.

The movement time T′_{S12} between belt position sensors that was actually measured in the black monochrome image formation mode was 1.84 seconds, and the movement time T_{S12} between belt position sensors in the black monochrome image formation mode was calculated to be 0.04 seconds. In view of this, the light-emission of the exposure section 12K is started 0.04 seconds earlier than the T_{LSK}, and the formation of a latent image on the photoreceptor 10K is started. On the other hand, the gate roller 71 begins operation 8.29 seconds later, which time T_{GS} and is the same as the full-color image formation mode. At this point, the timing at which the toner image carried on the intermediate transfer belt 40 enters into the secondary transfer nip 60 is the same time as the case of the full-color image formation mode, and can be accurately matched to the timing at which the transfer material enters the secondary transfer nip 60.

In the present embodiment, the detection signal of the belt position sensor 91 is used as a reference signal of each time, but no limitation is imposed thereby, and other signals can be used as a reference. For example, each time can be calculated using a secondary transfer roller home position sensor 93 as a reference.

Also, in the present embodiment, control for switching the light-emission timing of the exposure section is carried out on the basis of the movement time between belt position sensors as in the fourth embodiment, but the light-emission timing of the exposure section can switched on the basis of stored information as in the third embodiment.

In this manner, the time at which the exposure section starts light-emission is switched in the case that the state in which the intermediate transfer belt 40 wound around the photoreceptor has changed and the conveyance path of the intermediate transfer belt 40 from the primary transfer section to the secondary transfer section has changed in the full-color image formation mode and the black monochrome image formation mode, whereby the timing at which the toner image carried on the intermediate transfer belt 40 enters into the secondary transfer nip 60 and the timing at which the transfer material enters the secondary transfer nip 60 can be matched without changing the timing at which the transfer material is conveyed, and it is possible to obtain an image that has been transferred to a suitable position on the transfer material.

In the case that the state in which the intermediate transfer belt 40 wound around the photoreceptor has changed and the conveyance path of the intermediate transfer belt 40 from the primary transfer section to the secondary transfer section has changed in the full-color image formation mode and the black monochrome image formation mode, the method for matching the timing at which the toner image carried on the intermediate transfer belt 40 enters into the secondary transfer nip 60 and the timing at which the transfer material enters the secondary transfer nip 60 can be a method in which the time for starting the operation of the gate roller 71 is varied, but when the time for starting the operation of the gate roller 71 is varied in, e.g., the third embodiment, the positional relationship between the gripping member 64 of the secondary transfer roller 61 and the transfer material is offset. Accordingly, a method for switching the light-emission timing of the exposure section 12K is effective.

Various embodiments are described above, but the present embodiment is not limited to only these embodiments; embodiments in which the configurations of the embodiments have been suitably combined are also included in the scope of the invention.

What is claimed is:

1. A transfer device comprising:
a belt-shaped image carrier for carrying an image;
a drive roller for winding and moving the image carrier, which is carrying an image;
a first tension roller for imparting a tensile force to the image carrier and winding the image carrier moved by the drive roller;
a first elastic support part that has a first elastic member for generating the tensile force and that supports one rotating shaft of the first tension roller;
a second elastic support part that has a second elastic member for generating the tensile force and that supports another rotating shaft of the first tension roller;
a backup roller for winding the image carrier, which has been wound onto the tension roller;
a transfer roller that has a recess part in the peripheral surface and that makes contact with the image carrier wound on the backup roller to form a transfer nip; and
a second tension roller for imparting a tensile force to the image carrier and winding the image carrier wound on the backup roller.

2. An image formation apparatus comprising:
a belt-shaped image carrier for carrying an image;
an imaging section for forming an image and transferring the image to the image carrier;
a first drive source for generating driving force;
a drive roller for transmitting the driving force generated by the first drive source to the image carrier, and winding and driving the image carrier onto which the image has been transferred by the imaging section, the drive roller being connected to the first drive source;
a first tension roller for imparting a tensile force to the image carrier and winding the image carrier moved by the drive roller;
a first elastic support part that has a first elastic member for generating the tensile force and that supports one rotating shaft of the first tension roller;
a second elastic support part that has a second elastic member for generating the tensile force and that supports another rotating shaft of the first tension roller;
a backup roller for winding the image carrier, which has been wound onto the tension roller;
a second drive source for generating driving force;
a transfer roller that has a recess part in the peripheral surface, that makes contact with the image carrier wound on the backup roller to form a transfer nip, and that is rotatably driven by the second drive source; and
a second tension roller for imparting a tensile force to the image carrier and winding the image carrier wound on the backup roller.

3. The image formation apparatus according to claim 2, wherein the reverse-side surface opposite from the surface on which the image of the image carrier has been transferred is wound on the first tension roller and the second tension roller.

4. The image formation apparatus according to claim 2, further comprising
a cleaning section for making contact with the image carrier wound on the second tension roller to clean the image carrier; and
a second imaging section for forming an second image and transferring the second image to the image carrier cleaned by the cleaning unit, wherein
the imaging section transfers the image to the image carrier to which the second image has been transferred; and
the peripheral length of the image carrier from the transfer nip to the position in which the second imaging section transfers the image to the image carrier, along the direction of movement of the image carrier, is greater than the peripheral length of the image carrier from the position in which the imaging section transfers the image to the image carrier to the transfer nip.

5. The image formation apparatus according to claims 2, further comprising a steering roller on which the image carrier wound on the second tension roller is wound, and which adjusts the position of the drive roller of the image carrier in the axial direction.

6. The image formation apparatus according to claim 5, further comprising
a first side plate for supporting one of the rotating shafts of the drive roller, the rotating shafts of the first tension roller, the rotating shafts of the second tension roller, and rotating shafts of the steering roller;
a second side plate for supporting the other of the rotating shafts of the drive roller, the rotating shafts of the first tension roller, and the rotating shafts of the second tension roller;
a third side plate for supporting the other rotating shaft of the steering roller; and
a moving member for moving the third side plate.

7. The image formation apparatus according to claims 2, comprising
a first roller support member for supporting one of the rotating shafts of the second tension roller, the first roller support member having a third elastic member;
a second roller support member for supporting the other of the rotating shafts of the second tension roller, the second roller support member having a fourth elastic member; and
a coupling member connected to the first roller support member and the second roller support member.

8. The image formation apparatus according to claim 2, comprising a gripping mechanism for gripping a recording material to which the image has been transferred, the gripping mechanism being arranged in the recess part of the transfer roller.

9. An image formation apparatus comprising:
a first latent image carrier drum for carrying a latent image;
a first exposure section for exposing the first latent image carrier drum and forming the latent image;
a first development section for developing, using a first developer that includes a black-colored pigment, the latent image formed on the first latent image carrier;
a first transfer section for transferring a first image developed in the first development section;
a second latent image carrier drum for carrying a latent image;
a second exposure section for exposing the second latent image carrier drum and forming the latent image;
a second development section for developing, using a second developer, the latent image formed on the second latent image carrier;
a second transfer section for transferring a second image developed in the second development section;
an image-carrying belt onto which the first image is transferred, the image-carrying belt having been wound around the first latent image carrier drum in the first transfer section, and onto which the second image is transferred, the image-carrying belt having been wound around the second latent image carrier drum in the second transfer section;
a first tension roller around which is wound the image carrier onto which the first image and the second image have been transferred, the first tension roller adapted to impart tensile force to the image-carrying belt;
a stretch-out roller around which is wound the image-carrying belt that has been wound around the first tension roller;
a transfer roller for transferring to a transfer material the first image and the second image transferred on the image-carrying belt, upon contact having been made with the stretch-out roller interposed by the image-carrying belt;
a second tension roller around which is wound the image-carrying belt wound around the stretch-out roller, the second tension roller adapted to impart tensile force to the image-carrying belt;
a contact/separation mechanism for causing the second latent image carrier drum to make contact with or move away from the image-carrying belt; and
a controller for causing the second latent image carrier and the image-carrying belt to make contact with or move away from each other using the contact/separation mechanism, causing the first exposure section to expose at a first exposure timing when the second latent image carrier and the image-carrying belt have been brought into contact with each other, and causing the first exposure section to expose at second exposure timing that is different from the first exposure timing when the second latent image carrier and the image-carrying belt have been moved away from each other.

10. The image formation apparatus according to claim 9, comprising a detector for detecting the position of the image-carrying belt set in advance.

11. The image formation apparatus according to claim 10, wherein the controller controls the exposure of the first exposure section by using as a first exposure timing the elapsing of a first time after the position of the image-carrying belt set in advance is detected by the detector, and by using as a second exposure timing the elapsing of a second time that is different from the first time after the position of the image-carrying belt set in advance is detected by the detector.

12. The image formation apparatus according to claim 11, further comprising a storage section for storing information related to the first time and the second time.

13. The image formation apparatus according to claim 11, wherein the first time is later than the second time.

14. The image formation apparatus according to claim 10, wherein
the detector is arranged in a position upstream of where the first image and the second image are transferred and the image carrier is wound around the first tension roller;
the image formation apparatus further comprises:
a second stretch-out roller around which is wound the image-carrying belt, wound around the second tension roller, and
a second detector for detecting the position of the image-carrying belt set in advance, the second detector being arranged in a position upstream of where the image-carrying belt is wound over the stretch-out roller and wound over the second stretch-out roller; and
the controller controls the first exposure timing and the second exposure timing on the basis of the time beginning from when the detector detects the position of the image-carrying belt set in advance and the time ending when second detector detects the position of the image-carrying belt set in advance.

15. The image formation apparatus according to claim 9, wherein the transfer roller has a recess part in a peripheral surface, and has a gripping member for gripping the transfer material, the gripping member being arranged in the recess part.
